(19) United States
(12) Patent Application Publication
(10) Pub. No.: US 2023/0364888 A1
(43) Pub. Date: Nov. 16, 2023

(54) FOLDABLE APPARATUS

(71) Applicant: CORNING INCORPORATED, Corning, NY (US)

(72) Inventors: SUSHMIT SUNIL KUMAR GOYAL, PAINTED POST, NY (US); JENNY KIM, HORSEHEADS, NY (US); YOUSEF KAYED QAROUSH, PAINTED POST, NY (US); TINGGE XU, SANTA CLARA, CA (US)

(21) Appl. No.: 18/025,994

(22) PCT Filed: Sep. 13, 2021
(86) PCT No.: PCT/US2021/050016

§ 371 Date: Mar. 24, 2023

Related U.S. Application Data
(60) Provisional application No. 63/078,557, filed on Sep. 15, 2020.

(51) Int. Cl. B32B 17/10; G06F 1/16; H04M 1/02; B32B 7/12

(52) U.S. Cl. CPC B32B 17/10; B32B 7/12; G06F 1/1652; H04M 1/0268; B32B 2250/02; B32B 2307/418; B32B 2307/7376; B32B 2457/202

(57) ABSTRACT

Foldable apparatus comprise a plurality of first portions and at least one second portion positioned between a corresponding adjacent pair of first portions of the plurality of first portions. Each second portion of the at least one second portion comprises a maximum Young’s modulus ranging from about 500 times to about 500,000 times less than a minimum Young’s modulus of the corresponding adjacent pair of first portions. In some embodiments, the at least one second portion comprises at least five second portions. In some embodiments, each second portion of the at least one second portion comprises a thickness ranging from about 10 micrometers to about 250 micrometers. In some embodiments, each first portion comprises a first neutral plane and each second portion comprises a second neutral plane. In some embodiments, an apparatus bend force ranges from about 0.5 times to about 1 times a total bend force.

### CROSS-REFERENCE TO RELATED APPLICATION

This application claims the benefit of priority under 35 U.S.C. § 119 of U.S. Provisional Application Serial No. 63/078557 filed on Sep. 15, 2020, the content of which is relied upon and incorporated herein by reference in its entirety.

### FIELD

The present disclosure relates generally to foldable apparatus and, more particularly, to foldable apparatus comprising a foldable substrate.

### BACKGROUND

Foldable substrates are commonly used, for example, in display applications, for example, liquid crystal displays (LCDs), electrophoretic displays (EPD), organic light emitting diode displays (OLEDs), plasma display panels (PDPs), or the like.

There is a desire to develop foldable displays as well as foldable protective covers to mount on foldable displays. Foldable displays and foldable covers should have good impact and puncture resistance. At the same time, foldable displays and foldable covers should have small minimum bend radii (e.g., about 10 millimeters (mm) or less). However, plastic displays and covers with small minimum bend radii tend to have poor impact and/or puncture resistance. Furthermore, conventional wisdom suggests that ultra-thin glass-based sheets (e.g., about 75 micrometers (µm or microns) or less thick) with small minimum bend radii tend to have poor impact and/or puncture resistance. Furthermore, thicker glass-based sheets (e.g., greater than 125 micrometers) with good impact and/or puncture resistance tend to have relatively large minimum bend radii (e.g., about 30 millimeters or more). Moreover, foldable apparatus comprising thicker glass-based sheets can suffer from fatigue-related failure and/or have issues with mechanical reliability.

Consequently, there is a need to develop foldable substrates (e.g., glass-based substrates, ceramic-based substrates) for foldable apparatus that have low minimum bend radii and good impact and puncture resistance. Further, there is a need to develop foldable apparatus with reduced fatigue-based failure and/or good mechanical reliability.

### SUMMARY

There are set forth herein foldable apparatus and methods of making foldable apparatus that comprise foldable substrates. A foldable apparatus according to the embodiments of the disclosure can provide several technical benefits. For example, the foldable substrate can provide small effective minimum bend radii while simultaneously providing good impact and puncture resistance. The foldable apparatus can comprise glass-based and/or ceramic-based materials comprising one or more compressive stress regions, which can further provide increased impact resistance and/or puncture resistance while simultaneously facilitating good bending performance.

Providing at least one second portion comprising a much lower (e.g., from about 500 times to about 500,000 times, from about 10,000 times to about 100,000 times) Young’s modulus than an adj acent pair of first portions can reduce bend-induced stresses on one or more of the first portions in the adjacent pair of first portions. Reducing bend-induced stresses can reduce (e.g., decreases, eliminate) bend-induced mechanical instabilities of the foldable apparatus. Also, reducing bend-induced stresses can reduce fatigue of the foldable apparatus while increasing the reliability and/or durability of the foldable apparatus. Likewise, providing a second portion comprising a flexural rigidity of a second portion that is about 100 times or more less than a flexural rigidity of an adjacent first portion can reduce bend-induced stresses on the first portion, bend-induced mechanical instabilities in the foldable apparatus, and/or fatigue of the foldable apparatus.

Providing a foldable apparatus with an apparatus bend force near (e.g., within a factor of 2, from about 0.5 times to about 1 times) a total bend total bend force from bending each first portion individually can enable low user-applied forces to fold the foldable apparatus. Also, this can reflect a decreased coupling of bend-induced stresses between adjacent pairs of first portions.

Providing a foldable apparatus where each first portion comprises a first neutral plane and each second portion comprises a second neutral plane can reduce bend-induced stresses within the first portions and at least one second portion. As discussed above, reduced bend-induced stresses can reduce bend-induced mechanical instabilities in the foldable apparatus and/or fatigue of the foldable apparatus.

Some example embodiments of the disclosure are described below with the understanding that any of the features of the various embodiments may be used alone or in combination with one another.

Embodiment 1. A foldable apparatus comprises a plurality of first portions. The foldable apparatus comprises at least one second portion positioned between a corresponding adjacent pair of first portions of the plurality of first portions. The at least one second portion comprises at least five second portions. Each second portion of the at least five second portions comprises a maximum Young’s modulus that in a range from about 500 times to about 500,000 times a minimum Young’s modulus of the corresponding adjacent pair of first portions.

Embodiment 2. The foldable apparatus of embodiment 1, wherein each second portion of the at least five second portions comprises a thickness in a range from about 10 micrometers to about 250 micrometers.

Embodiment 3. A foldable apparatus comprises a plurality of first portions. The foldable apparatus comprises at least one second portion positioned between a corresponding adjacent pair of first portions of the plurality of first portions. Each second portion of the at least one second portion comprises a maximum Young’s modulus that is in a range from about 500 times to about 500,000 times less than a minimum Young’s modulus of the corresponding adjacent pair of first portions. Each second portion of the at least one second portion comprises a thickness in a range from about 10 micrometers to about 250 micrometers.

Embodiment 4. The foldable apparatus of any one of embodiments 2-3, wherein the thickness of the at least one second portion is in a range from about 25 micrometers to about 100 micrometers.

Embodiment 5. The foldable apparatus of any one of embodiments 1-4, wherein each first portion of the corresponding adjacent portion of first portions comprises a first neutral plane. Each second portion of the at least one second portion comprises a second neutral plane.

Embodiment 6. A foldable apparatus comprising a plurality of first portions. Each first portion of the plurality of first portions comprises a first neutral plane. The foldable apparatus comprises at least one second portion positioned between a corresponding adjacent pair of first portions of the plurality of first portions. Each second portion of the at least one second portion comprises a second neutral plane. Each second portion of the at least one second portion comprises a maximum Young’s modulus that is in a range from about 500 times to about 500,000 times less than a minimum Young’s modulus of the corresponding adjacent pair of first portions.

Embodiment 7. The foldable apparatus of any one of embodiments 1-6, wherein an apparatus bend force is in a range from about 0.5 times to about 1 times a total bend force comprises a force to bend each first portion of the plurality first portions individuals and the at least one second portion individually.

Embodiment 8. A foldable apparatus comprises a plurality of first portions. The foldable apparatus comprises at least one second portion positioned between a corresponding adjacent pair of first portions of the plurality of first portions. Each second portion of the at least one second portion comprises a maximum Young’s modulus that is in a range from about 500 times to about 500,000 times less than a minimum Young’s modulus of the corresponding adjacent pair of first portions. An apparatus bend force is in a range from about 0.5 times to about 1 times a total bend force comprises a force to bend each first portion of the plurality first portions individuals and the at least one second portion individually.

Embodiment 9. The foldable apparatus of any one of embodiments 1-8, wherein each second portion of the at least one second portion comprises a maximum Young’s modulus that is in a range from about 10,000 times to about 100,000 times less than a minimum Young’s modulus of the corresponding adjacent pair of first portions.

Embodiment 10. The foldable apparatus of any one of embodiments 1-9, wherein each second portion of the at least one second portion comprises a maximum Young’s modulus of about 0.5 MegaPascals or less.

Embodiment 11. The foldable apparatus of embodiment 10, wherein the maximum Young’s modulus of each second portion of the at least one second portion is in a range from about 0.01 MegaPascals to about 0.1 MegaPascals.

Embodiment 12. The foldable apparatus of any one of claims 1-11, wherein each second portion of the at least one second portion comprises a Poisson’s ratio of about 0.49 or more.

Embodiment 13. The foldable apparatus of embodiment 12, wherein the Poisson’s ratio of each second portion of the at least one second portion is in a range from about 0.495 to about 0.500.

Embodiment 14. The foldable apparatus of any one of embodiments 1-13, wherein a flexural rigidity of each second portion of the at least one second portion is less than a flexural rigidity of a first portion of the corresponding adjacent pair of first portions by about 1,000 or more.

Embodiment 15. The foldable apparatus of embodiment 14, wherein the flexural rigidity of each second portion of the at least one second portion is less than the flexural rigidity of the first portion of the corresponding adjacent pair of first portions by about 4,000 times to about 40,000 times.

Embodiment 16. The foldable apparatus of any one of embodiments 1-15, wherein a number of second portions of the at least one second portion is one less than a number of first portions of the plurality of first portions.

Embodiment 17. The foldable apparatus of any one of embodiments 1-16, wherein at least one first portion of the plurality of first portions comprises two or more first sub-portions. One first sub-portion of the two or more first sub-portions comprises a different composition than a composition of another first sub-portion of the two or more first sub-portions.

Embodiment 18. The foldable apparatus of embodiment 17, wherein the two or more first sub-portions comprises three or more first sub-portions further comprising an additional first sub-portion. The additional first sub-portion is positioned between the one first sub-portion and the another first sub-portion.

Embodiment 19. The foldable apparatus of any one of embodiments 17-18, wherein a second portion of the at least one second portion adjacent to the at least one first portion contacts the one first sub-portion but not the another first sub-portion.

Embodiment 20. The foldable apparatus of any one of embodiments 1-19, wherein a magnitude of a difference between an index of refraction of the at least one second portion and the index of refraction of an adjacent first portion of the corresponding adjacent pair of first portions is about 0.1 or less.

Embodiment 21. The foldable apparatus of any one of embodiments 1-20, wherein the at least one second portion comprises an optically clear adhesive and/or a pressure sensitive adhesive.

Embodiment 22. The foldable apparatus of any one of embodiments 1-21, wherein the at least one second portion comprises one or more of a silicone-based polymer, an acrylate-based polymer, an epoxy-based polymer, a thiol-containing polymer, a polyimide-based material, or a polyurethane.

Embodiment 23. The foldable apparatus of any one of embodiments 1-22, wherein the at least one second portion comprises nanoparticles of one or more of silica, alumina, kaolin, and/or hydroxyapatite.

Embodiment 24. The foldable apparatus of any one of embodiments 1-22, wherein the at least one second portion comprises particles of one or more of copper oxide, beta-quartz, a tungstate, a vanadate, a pyrophosphate, and/or a nickel-titanium alloy.

Embodiments 25. The foldable apparatus of any one of embodiments 1-24, wherein at least one first portion of the plurality of first portions comprises a glass-based substrate.

Embodiment 26. The foldable apparatus of any one of embodiments 1-24, wherein at least one first portion of the plurality of first portions comprises a ceramic-based substrate.

Embodiment 27. A consumer electronic product comprises a housing comprising a front surface, a back surface, and side surfaces. The consumer electronic product comprises electrical components at least partially within the housing. The electrical components comprising a controller, a memory, and a display. The display is at or adjacent to the front surface of the housing. The consumer electronic product comprises a cover substrate disposed over the display. At least one of a portion of the housing or the cover substrate comprises the foldable apparatus of any one of embodiments 1-26.

### BRIEF DESCRIPTION OF THE DRAWINGS

The above and other features and advantages of embodiments of the present disclosure are better understood when the following detailed description is read with reference to the accompanying drawings, in which:

FIG. 1 is a schematic view of an example foldable apparatus in a flat configuration according to some embodiments, wherein a schematic view of the folded configuration may appear as shown in FIG. 9;

FIG. 2 is a schematic cross-sectional view of the foldable apparatus along line 2-2 of FIG. 1 according to some embodiments;

FIG. 3 is a cross-sectional view of another foldable apparatus along line 2-2 of FIG. 1 according to some embodiments;

FIG. 4 is a cross-sectional view of another foldable apparatus along line 2-2 of FIG. 1 according to some embodiments;

FIG. 5 is a cross-sectional view of another foldable apparatus along line 2-2 of FIG. 1 according to some embodiments;

FIG. 6 is a cross-sectional view of another foldable apparatus along line 2-2 of FIG. 1 according to some embodiments;

FIG. 7 is a cross-sectional view of another foldable apparatus along line 2-2 of FIG. 1 according to some embodiments;

FIG. 8 is a cross-sectional view of another foldable apparatus along line 2-2 of FIG. 1 according to some embodiments;

FIG. 9 is a schematic view of another example foldable apparatus in a folded configuration according to some embodiments, wherein a schematic view of the flat configuration may appear as shown in FIG. 1;

FIG. 10 is a cross-sectional view of the example foldable apparatus in the folded configuration along line 10-10 of FIG. 9 according to some embodiments;

FIG. 11 schematically shows a view of a foldable apparatus with a mechanical instability in a folded configuration;

FIG. 12 schematically shows a view of a foldable apparatus with another mechanical instability in a folded configuration;

FIG. 13 schematic plan view of an example consumer electronic device according to some embodiments;

FIG. 14 is a schematic perspective view of the example consumer electronic device of FIG. 13;

FIG. 15 is a plot of strain as a function of depth through the thickness of a foldable apparatus resembling FIG. 4;

FIG. 16 is a plot of strain as a function of depth through the thickness of a foldable apparatus resembling FIG. 4;

FIG. 17 is a plot of strain as a function of depth through the thickness of a foldable apparatus resembling FIG. 5;

FIG. 18 is a plot of strain as a function of depth through the thickness of a foldable apparatus resembling FIG. 5;

FIG. 19 is a plot of strain as a function of depth through the thickness of a foldable apparatus resembling FIG. 6;

FIG. 20 is a plot of strain as a function of depth through the thickness of a foldable apparatus resembling FIG. 7;

FIG. 21 is a plot of strain as a function of depth through the thickness of a foldable apparatus resembling FIG. 8; and

FIG. 22 is a plot of strain as a function of depth through the thickness of a foldable apparatus resembling FIG. 8.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, claims may encompass many different aspects of various embodiments and should not be construed as limited to the embodiments set forth herein.

Throughout the disclosure, the drawings are used to emphasize certain aspects. As such, it should not be assumed that the relative size of the different layers, coatings, portions, and substrates shown in the drawings are proportional to its actual relative size, unless explicitly indicated otherwise.

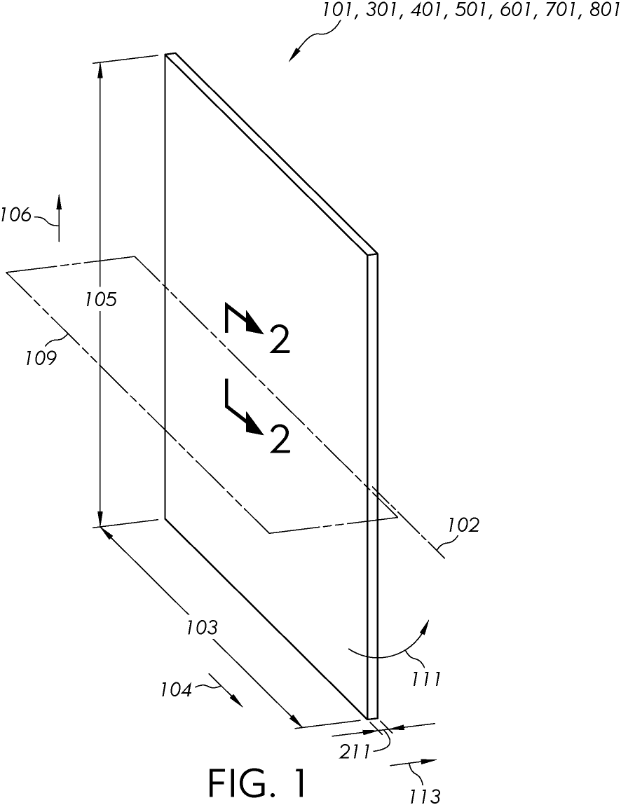

FIGS. 1-8 illustrate views of foldable apparatus 101, 301, 401, 501, 601, 701, and 801 in accordance with embodiments of the disclosure. Unless otherwise noted, a discussion of features of embodiments of one foldable apparatus can apply equally to corresponding features of any of the embodiments of the disclosure. For example, identical part numbers throughout the disclosure can indicate that, in some embodiments, the identified features are identical to one another and that the discussion of the identified feature of one embodiment, unless otherwise noted, can apply equally to the identified feature of any of the other embodiments of the disclosure.

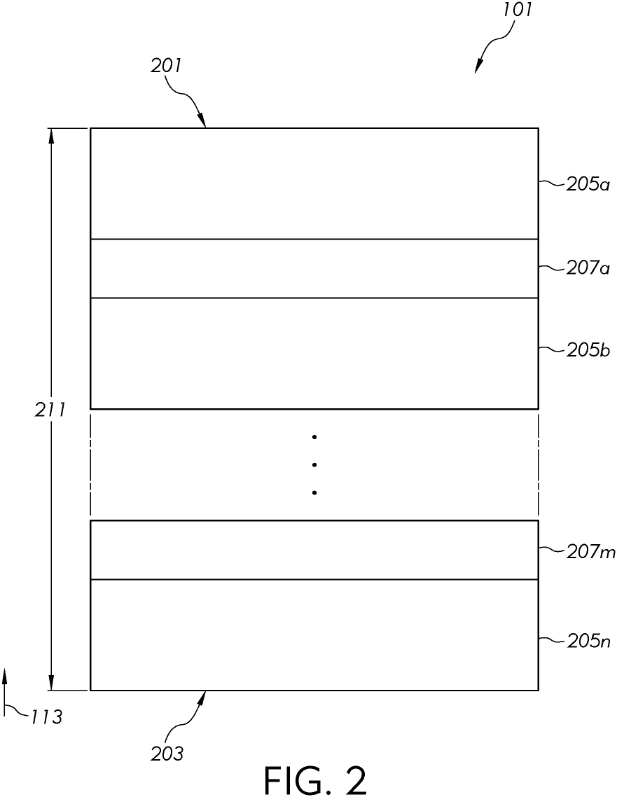

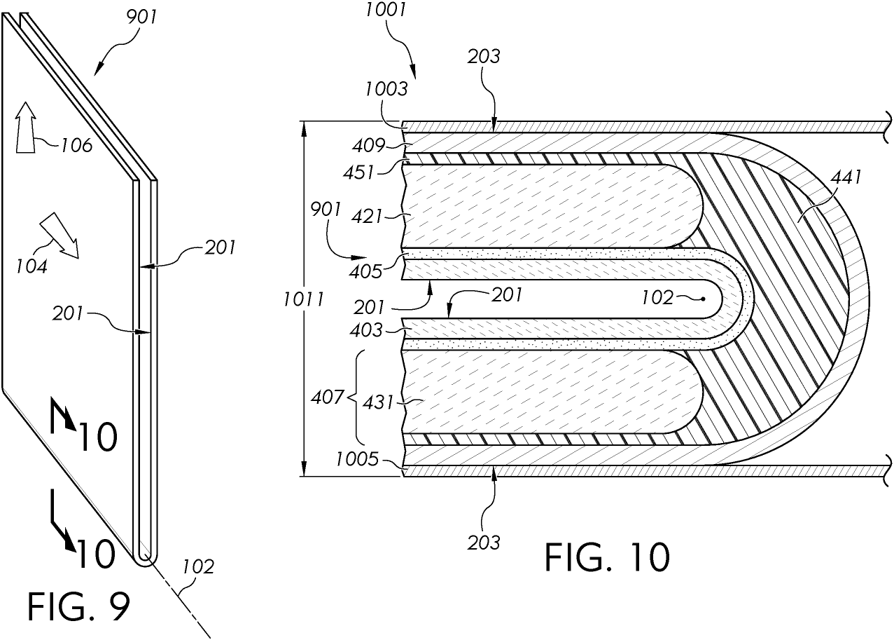

FIGS. 1-8 schematically illustrate example embodiments of foldable apparatus 101, 301, 401, 501, 601, 701, and 801 in accordance with embodiments of the disclosure in an unfolded (e.g., flat) configuration while FIGS. 9-10 demonstrate a foldable apparatus 901 in accordance with embodiments of the disclosure in a folded configuration. As shown in FIGS. 2-8, the foldable apparatus 101, 301, 401, 501, 601, 701, and 801 can comprise three or more layers. The three or more layers comprise at least a one second portion positioned between an adjacent pair of first portions of a plurality of first portions. In some embodiments, as shown in FIGS. 4 and 10, the foldable apparatus 401 and 901 can comprise a first sub-portion 421, an another first sub-portion 431, and a polymer-based sub-portion 441 positioned between the first sub-portion 421 to the another first sub-portion 431. In some embodiments, the foldable apparatus can comprise a display device and/or a cover substrate (e.g., glass-based substrate, ceramic-based substrate), for example, as a first portion of the plurality of first portions.

Throughout the disclosure, with reference to FIG. 1, a width 103 of the foldable apparatus is considered the dimension of the foldable apparatus taken between opposed edges of the foldable apparatus in a direction 104 of a fold axis 102 of the foldable apparatus. Furthermore, throughout the disclosure, the length 105 of the foldable apparatus is considered the dimension of the foldable apparatus taken between opposed edges of the foldable apparatus in a direction 106 perpendicular to the fold axis 102 of the foldable apparatus.

FIGS. 1-8 schematically illustrate example embodiments of foldable apparatus 101, 301, 401, 501, 601, 701, and 801 in accordance with embodiments of the disclosure in an unfolded (e.g., flat) configuration. As shown in FIGS. 2-8, the foldable apparatus 101, 301, 401, 501, 601, 701, and 801 can comprise a first major surface 201 and a second major surface 203 opposite the first major surface 201. As shown, the first major surface 201 can comprise a planar surface. The second major surface 203 can comprise a planar surface. In some embodiments, as shown, the first major surface 201 can be parallel to the second major surface 203. In some embodiments, although not show, the first major surface and/or second major surface can comprise a curved surface and/or a curvilinear surface. In some embodiments, as shown in FIG. 2, an apparatus thickness 211 can be defined between the first major surface 201 and the second major surface 203. In further embodiments, the apparatus thickness 211 can be about 10 micrometers (µm) or more, about 20 µm or more, about 40 µm or more, about 60 µm or more, about 80 µm or more, about 100 µm or more, about 200 µm or more, about 400 µm, about 5 millimeters (mm) or less, about 2 mm or less, about 1 mm or less, about 800 µm or less, about 600 µm or less, or about 500 µm or less. In further embodiments, the apparatus thickness 211 can be in a range from about 10 µm to about 5 mm, from about 10 µm to about 2 mm, from about 20 µm to about 2 mm, from about 40 µm to about 2 mm, from about 40 µm to about 1 mm, from about 60 µm to about 1 mm, about 80 µm to about 1 mm, from about 80 µm to about 800 µm, from about 100 µm to about 800 µm, from about 200 µm to about 800 µm, from about 200 µm to about 600 µm, from about 200 µm to about 500 µm, from about 400 µm to about 500 µm, or any range or subrange therebetween.

As shown in FIGS. 2-8, the foldable apparatus 101, 301, 401, 501, 601, 701, and 801 comprises a plurality of first portions. Throughout the disclosure, the plurality of first portions can be arranged as a stack in a direction 113 of the apparatus thickness 211. For example, as shown in FIGS. 2-8, the plurality of first portions are arranged sequentially as a stack in the direction 113 of the apparatus thickness 211. For example, in FIG. 2, the foldable apparatus can comprise a plurality of first portions 205a-n. In some embodiments, as shown in FIGS. 2-8, a surface of a first portion 205a, 303, 403, 503, 603, 703, and 803 can comprises the first major surface 201. As discussed below, in some embodiments, a second portion can be positioned between an adjacent pair of first portions of the plurality of first portions. In further embodiments, each adjacent pair of first portion can have a corresponding second portion positioned therebetween. In some embodiments, as shown in FIGS. 2-8, a surface of a first portion 205n, 307, 409, 511, 615, 719, 823 can comprise the second major surface 203. In further embodiments, as shown, a surface of a first portion 205a, 303, 403, 503, 603, 703, and 803 can comprises the first major surface 201 and a surface of an another first portion 205n, 307, 409, 511, 615, 719, 823 can comprise the second major surface 203.

In some embodiments, a first portion of the plurality of first portions can comprise a Young’s modulus. As used herein, the Young’s modulus is a ratio of uniaxial stress to strain. Throughout the disclosure, a tensile strength, ultimate elongation (e.g., strain at failure), and yield point of a polymeric material (e.g., adhesive, polymer-based portion) is determined using ASTM D638 using a tensile testing machine, for example, an Instron 3400 or Instron 6800, at 23° C. and 50% relative humidity with a type I dogbone shaped sample. Throughout the disclosure, a Young’s modulus and/or a Poisson’s ratio is measured using ISO 527-1:2019. In some embodiments, a first portion can comprise more than one material, as discussed below. As used herein, the maximum Young’s modulus of a portion is the maximum Young’s modulus of all the materials comprising the portion. As used herein, the minimum Young’s modulus of a portion is the minimum Young’s modulus of all the materials comprising the portion. In some embodiments, a maximum Young’s modulus of a first portion of the plurality of first portions can be about 500 MegaPascals (MPa) or more, about 1 GigaPascal (GPa) or more, about 5 GPa or more, about 10 GPa or more, about 40 GPa or more, about 50 GPa or more, about 100 GPa or less, about 90 GPa or less, about 80 GPa or less, about 70 GPa or less, about 60 GPa or less. In some embodiments, the maximum Young’s modulus of the first portion of the plurality of first portions can be in a range from about 500 MPa to about 100 GPa, from about 1 GPa to about 100 GPa, from about 1 GPa to about 90 GPa, from about 5 GPa to about 90 GPa, from about 5 GPa to about 80 GPa, from about 10 GPa to about 80 GPa, from about 40 GPa to about 80 GPa, from about 40 GPa to about 70 GPa, from about 50 GPa to about 70 GPa, from about 50 GPa to about 60 GPa, or any range or subrange therebetween. In some embodiments, a maximum value of the maximum Young’s modulus of all of the first portions of the plurality of first portions can be within one or more of the ranges listed above. In some embodiments, a minimum Young’s modulus of a first portion of the plurality of first portions can be within one or more of the ranges discussed above for the maximum Young’s modulus of the first portion. In some embodiments, a minimum value of the minimum Young’s modulus of all of the first portions of the plurality of first portions can be within one or more of the ranges listed above for the maximum Young’s modulus. It is to be understood that a first portion can comprise a maximum Young’s modulus within one or more of the ranges discussed above without a corresponding minimum Young’s modulus being within one or more of the ranges discussed above.

As used herein, Poisson’s ratio is a ratio of a lateral expansion resulting from an axial compression to the axial contraction from the axial compression. Without wishing to be bound by theory, a Poisson’s ratio of 0.5 corresponds to an incompressible isotropic material, meaning that the volume of the material does not change as a result of axial compression. As used herein, the maximum Poisson’s ratio of a portion is the maximum Poisson’s ratio of all the materials comprising the portion. As used herein, the minimum Poisson’s ratio of a portion is the minimum Poisson’s ratio of all the materials comprising the portion. In some embodiments, a first portion can comprise a maximum Poisson’s ratio of about 0.05 or more, about 0.10 or more, about 0.20 or more, about 0.25 or more, about 0.50 or less, about 0.40 or less, about 0.35 or less, or about 0.30 or less. In some embodiments, a first portion can comprise a maximum Poisson’s ratio in a range from about 0.05 to about 0.50, from about 0.10 to about 0.50, from about 0.10 to about 0.40, from about 0.20 to about 0.40, from about 0.20 to about 0.35, from about 0.25 to about 0.35, from about 0.25 to about 0.30, or any range or subrange therebetween. In some embodiments, a maximum value of the maximum Poisson’s ratio of all of the first portions of the plurality of first portions can be within one or more of the ranges listed above. In some embodiments, a minimum Poisson’s ratio of a first portion of the plurality of first portions can be within one or more of the ranges discussed above for the maximum Poisson’s ratio of the first portion. In some embodiments, a minimum value of the minimum Poisson’s ratio of all of the first portions of the plurality of first portions can be within one or more of the ranges listed above for the maximum Poisson’s ratio.

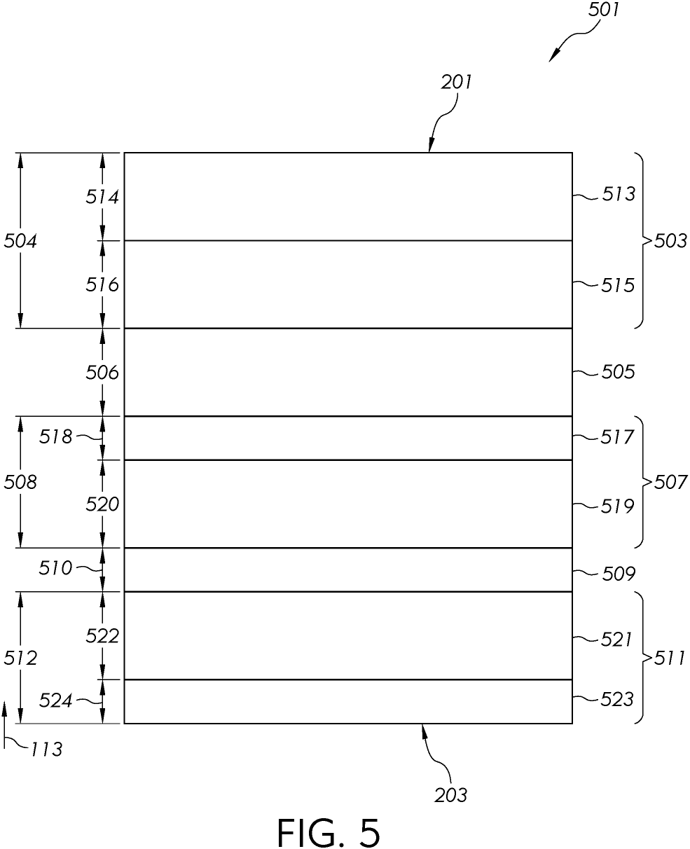

In some embodiments, a first portion of the plurality of first portions can comprise multiple first sub-portions. In further embodiments, a first portion can comprise two or more first sub-portions. For example, as shown in FIG. 5, the first portion 503 can comprise a one first sub-portion 513 and an another first sub-portion 515. In even further embodiments, as shown in FIG. 5, the one first sub-portion 513 can comprise a different composition (e.g., material) than the another first sub-portion 515 of the two or more first sub-portions. Similarly, in FIG. 5, a yet another first portion 511 can comprise a one first sub-portion 521 and an another first sub-portion 523, and the one first sub-portion 521 can comprise a different composition than a composition of the another first sub-portion 523. Likewise, in FIG. 5, an another first portion 507 of the plurality of first portions can comprise a one first sub-portion 517 and an another first sub-portion 519, and the one first sub-portion 517 can comprise a different composition than a composition of the another first sub-portion 519. In further embodiments, as shown in FIG. 5, the two or more first sub-portions can be arranged in the direction 113 of the apparatus thickness 211 (see FIG. 2). For example, as shown in FIG. 5, the one first sub-portion 517 of the another first portion 507 can be positioned above the another first sub-portion 519 of the another first portion 507 in the direction 113 of the apparatus thickness 211. In further embodiments, as shown in FIG. 5, the one first sub-portion 517 of the another first portion 507 can contact a second portion 505 adjacent to the another first portion 507 but not contact an another second portion 509 adjacent to the another first portion 507. In even further embodiments, as shown, the another first sub-portion 519 of the another first portion 507 can contact the another second portion 509 adjacent to the another first portion 507 but not contact the second portion 505 adjacent to the another first portion 507. In still further embodiments, the one first sub-portion 517 of the another first portion 507 can contact the another first sub-portion 519 of the another first portion 507.

In some embodiments, a first portion of the plurality of first portions can comprise three or more first sub-portions. In further embodiments, as shown in FIG. 4, a first portion 407 can comprise a one first sub-portion 421, an another first sub-portion 431, and an additional first sub-portion 441. In even further embodiments, as shown, the additional first sub-portion 441 can be positioned between the one first sub-portion 421 and the another first sub-portion 431. In still further embodiments, as shown, additional first sub-portion 441 can contact the one first sub-portion 421 and the another first sub-portion 431. In still further embodiments, the one first sub-portion 421 and the another first sub-portion 431 can both contact an adjacent second portion 405. In still further embodiments, as shown, the three or more first sub-portions can be at substantially the same position in the direction 113 of the apparatus thickness 211 (see FIG. 2). In still further embodiments, as shown, the three or more first sub-portions can be arranged in a direction (e.g., direction 106 shown in FIG. 1) substantially perpendicular to the direction 113 of the apparatus thickness 211.

As shown in FIG. 4, a first portion comprising reference numbers 407 and 409 of the foldable apparatus 401 can comprise a first sub-portion 421 and an another first sub-portion 431 with a polymer-based sub-portion 441 positioned therebetween. In some embodiments, the first sub-portion 421 can comprise a first glass-based portion. In some embodiments, the first sub-portion 421 can comprise a first ceramic-based portion. In some embodiments, the first sub-portion 421 can comprise a thickness substantially equal to a thickness of the another first sub-portion 431. In some embodiments, the thickness of the first sub-portion 421 may be substantially uniform across a corresponding length 105 of the foldable apparatus 101 (see FIG. 1) and/or a corresponding width 103 of the foldable apparatus 101 (see FIG. 1). As further shown in FIG. 4, in some embodiments, the another first sub-portion 431 can comprise a second glass-based portion. In some embodiments, the another first sub-portion 431 can comprise a second ceramic-based portion. In some embodiments, the thickness of the another first sub-portion 431 may be substantially uniform across its corresponding length 105 and/or its corresponding width 103.

As further shown in FIG. 4, the first sub-portion 421 can comprise a first surface area 427 and a second surface area 429 opposite the first surface area 427. The first sub-portion 421 can comprise a first edge surface 423 extending between the first surface area 427 and the second surface area 429. The first edge surface 423 can comprise an outer peripheral portion 425. In some embodiments, although not shown, the first edge surface 423 can comprise a substantially right angle with the first surface area 427 and/or the second surface area 429. In some embodiments, as shown in FIG. 4, the first edge surface 423 can comprise a blunted edge surface. As used herein, a portion is considered to have a blunted edge if a surface of the edge forms an obtuse internal angle with the first surface area at an intersection between the first surface area and the surface of the edge and/or if a surface of the edge forms an obtuse internal angle with the second surface area at an intersection between the second surface area and the surface of the edge. As used herein, an internal angle is measured internally within the portion. As used herein, an obtuse angle is greater than 90 degrees and less than 180 degrees. For example, a blunted edge surface can be a chamfered edge surface, a curved surface, a rounded edge surface, an elliptical edge surface, a circular edge surface, or a combination thereof (e.g., compound edge surface).

As shown in FIG. 4, the another first sub-portion 431 can comprise a third surface area 437 and a fourth surface area 439 opposite the third surface area 437. The another first sub-portion 431 can comprise a second edge surface 433 extending between the third surface area 437 and the fourth surface area 439. The second edge surface 433 can comprise an outer peripheral portion 435. In some embodiments, although not shown, the second edge surface 433 can comprise a substantially right angle with the third surface area 437 and/or the fourth surface area 439. In some embodiments, as shown in FIG. 4, the second edge surface 433 can comprise a blunted edge surface. In some embodiments, as shown, the second edge surface 433 can substantially be a mirror image of the first edge surface 423.

Foldable apparatus 101, 301, 401, 501, 601, 701, and 801 of the disclosure can comprise a first portion of the plurality of first portions comprising a foldable substrate. In some embodiments, the foldable substrate can comprise a glass-based substrate and/or a ceramic-based substrate having a pencil hardness of 8H or more, for example, 9H or more.

In some embodiments, a first portion can comprise a foldable substrate comprising a glass-based substrate. As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion-exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In one or more embodiments, a glass-based material may comprise, in mole percent (mol %): SiO₂ in a range from about 40 mol % to about 80%, Al₂O₃ in a range from about 5 mol % to about 30 mol %, B₂O₃ in a range from 0 mol % to about 10 mol %, ZrO₂ in a range from 0 mol % to about 5 mol %, P₂O₅ in a range from 0 mol % to about 15 mol %, TiO₂ in a range from 0 mol % to about 2 mol %, R₂O in a range from 0 mol % to about 20 mol %, and RO in a range from 0 mol % to about 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In some embodiments, a glass-based substrate may optionally further comprise in a range from 0 mol % to about 2 mol % of each of Na₂SO₄, NaCl, NaF, NaBr, K₂SO₄, KCl, KF, KBr, AS₂O₃, Sb₂O₃, SnO₂, Fe₂O₃, MnO, MnO₂, MnO₃, Mn₂O₃, Mn₃O₄, Mn₂O₇. “Glass-ceramics” include materials produced through controlled crystallization of glass. In some embodiments, glass-ceramics have about 1% to about 99% crystallinity. Examples of suitable glass-ceramics may include Li₂O-Al₂O₃-SiO₂ system (i.e. LAS-System) glass-ceramics, MgO-Al₂O₃-SiO₂ system (i.e. MAS-System) glass-ceramics, ZnO × Al₂O₃ × nSiO₂ (i.e. ZAS system), and/or glass-ceramics that include a predominant crystal phase including β-quartz solid solution, β-spodumene, cordierite, petalite, and/or lithium disilicate. The glass-ceramic substrates may be strengthened using the chemical strengthening processes. In one or more embodiments, MAS-System glass-ceramic substrates may be strengthened in Li₂SO₄ molten salt, whereby an exchange of 2Li⁺ for Mg²⁺ can occur.

In some embodiments, a first portion can comprise a foldable substrate comprising a ceramic-based substrate. As used herein, “ceramic-based” includes both ceramics and glass-ceramics, wherein glass-ceramics have one or more crystalline phases and an amorphous, residual glass phase. Ceramic-based materials may be strengthened (e.g., chemically strengthened). In some embodiments, a ceramic-based material can be formed by heating a glass-based material to form ceramic (e.g., crystalline) portions. In further embodiments, ceramic-based materials may comprise one or more nucleating agents that can facilitate the formation of crystalline phase(s). In some embodiments, the ceramic-based materials can comprise one or more oxide, nitride, oxynitride, carbide, boride, and/or silicide. Example embodiments of ceramic oxides include zirconia (ZrO₂), zircon zirconia (ZrSiO₄), an alkali metal oxide (e.g., sodium oxide (Na₂O)), an alkali earth metal oxide (e.g., magnesium oxide (MgO)), titania (TiO₂), hafnium oxide (Hf₂O), yttrium oxide (Y₂O₃), iron oxide, beryllium oxide, vanadium oxide (VO₂), fused quartz, mullite (a mineral comprising a combination of aluminum oxide and silicon dioxide), and spinel (MgAl₂O₄). Example embodiments of ceramic nitrides include silicon nitride (Si₃N₄), aluminum nitride (AlN), gallium nitride (GaN), beryllium nitride (Be₃N₂), boron nitride (BN), tungsten nitride (WN), vanadium nitride, alkali earth metal nitrides (e.g., magnesium nitride (Mg₃N₂)), nickel nitride, and tantalum nitride. Example embodiments of oxynitride ceramics include silicon oxynitride, aluminum oxynitride, and a SiAlON (a combination of alumina and silicon nitride and can have a chemical formula, for example, Si₁₂₋ₘ₋ₙAlₘ₊ₙOₙN₁₆₋ₙ, Si₆₋ₙAlₙOₙN₈₋ₙ, or Si₂₋ₙAlₙOₗ₊ₙN₂₋ₙ, where m, n, and the resulting subscripts are all non-negative integers). Example embodiments of carbides and carbon-containing ceramics include silicon carbide (SiC), tungsten carbide (WC), an iron carbide, boron carbide (B₄C), alkali metal carbides (e.g., lithium carbide (Li₄C₃)), alkali earth metal carbides (e.g., magnesium carbide (Mg₂C₃)), and graphite. Example embodiments of borides include chromium boride (CrB₂), molybdenum boride (Mo₂B₅), tungsten boride (W₂B₅), iron boride, titanium boride, zirconium boride (ZrB₂), hafnium boride (HfB₂), vanadium boride (VB₂), Niobium boride (NbB₂), and lanthanum boride (LaB₆). Example embodiments of silicides include molybdenum disilicide (MoSi₂), tungsten disilicide (WSi₂), titanium disilicide (TiSi₂), nickel silicide (NiSi), alkali earth silicide (e.g., sodium silicide (NaSi)), alkali metal silicide (e.g., magnesium silicide (Mg₂Si)), hafnium disilicide (HfSi₂), and platinum silicide (PtSi).

In some embodiments, the foldable apparatus may comprise a first portion comprising a glass-based substrate and/or ceramic-based substrate where one or more portions of the foldable substrate may comprise a compressive stress region. In some embodiments, the compressive stress region may be created by chemically strengthening the foldable substrate. Chemically strengthening may comprise an ion exchange process, where ions in a surface layer are replaced by—or exchanged with— larger ions having the same valence or oxidation state. Without wishing to be bound by theory, chemically strengthening the foldable substrate can enable small (e.g., smaller than about 10 mm or less) bend radii because the compressive stress from the chemical strengthening can counteract the bend-induced tensile stress on the outermost surface of the foldable substrate (e.g., second major surface 203 in FIG. 10). A compressive stress region may extend into a portion of the foldable substrate for a depth called the depth of compression. As used herein, depth of compression means the depth at which the stress in the chemically strengthened substrates described herein changes from compressive stress to tensile stress. Depth of compression may be measured by a surface stress meter or a scattered light polariscope (SCALP) depending on the ion exchange treatment and the thickness of the article being measured. Where the stress in the substrate is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 75 µm, SCALP is used to measure the depth of compression and central tension (CT). Where the stress in the substrate is generated by exchanging both potassium and sodium ions into the glass, and the article being measured is thicker than about 75 µm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate (e.g., sodium, potassium). Through the disclosure, when the central tension cannot be measured directly by SCALP (as when the article being measured is thinner than about 75 µm) the maximum central tension can be approximated by a product of a maximum compressive stress and a depth of compression divided by the difference between the thickness of the substrate and twice the depth of compression, wherein the compressive stress and depth of compression are measured by FSM.

In some embodiments, a glass-based substrate and/or ceramic-based substrate can comprise a compressive stress region. In further embodiments, the glass-based substrate and/or ceramic-based substrate may be chemically strengthened to a first depth of compression, as a percentage of the corresponding thickness, can be about 1% or more, about 5% or more, about 10% or more, about 30% or less, about 25% or less, or about 20% or less. In even further embodiments, the first depth of compression, as a percentage of the corresponding thickness, can be in a range from about 1% to about 30%, from about 1% to about 25%, from about 1% to about 20%, from about 5% to about 30%, from about 5% to about 25%, from about 5% to about 20%, from about 10% to about 30%, from about 10% to about 25%, from about 10% to about 20%, or any range or subrange therebetween. In further embodiments, the first depth of compression can be about 1 µm or more, about 10 µm or more, about 50 µm or more, about 200 µm or less, about 150 µm or less, or about 100 µm or less. In further embodiments, the first depth of compression can be in a range from about 1 µm to about 200 µm, from about 1 µm to about 150 µm, from about 1 µm to about 100 µm, from about 10 µm to about 200 µm, from about 10 µm to about 150 µm, from about 10 µm to about 100 µm, from about 50 µm to about 200 µm, from about 50 µm to about 150 µm, or any range or subrange therebetween. By providing a glass-based and/or ceramic-based portion comprising a first depth of compression (e.g., chemically strengthened) in a range from about 1% to about 30% of the corresponding thickness, good impact and/or puncture resistance of the foldable apparatus can be enabled.

In some embodiments, the compressive stress region of the glass-based substrate and/or ceramic-based substrate can comprise a first maximum compressive stress. In further embodiments, the maximum compressive stress can be about 100 MegaPascals (MPa) or more, about 200 MPa or more, about 400 MPa or more, about 600 MPa or more, about 700 MPa or more, about 1,500 MPa or less, about 1,200 MPa or less, about 1,000 MPa or less, or about 800 MPa or less. In further embodiments, the maximum compressive stress can be in a range from about 100 MPa to about 1,500 MPa, from about 200 MPa to about 1,500 MPa, from about 200 MPa to about 1,200 MPa, from about 400 MPa to about 1,200 MPa, from about 400 MPa to about 1,000 MPa, from about 600 MPa to about 1,000 MPa, from about 600 MPa to about 800 MPa, or any range or subrange therebetween. Providing a maximum compressive stress in a range from about 100 MPa to about 1,500 MPa can enable good impact and/or puncture resistance of the foldable apparatus. In some embodiments, the glass-based substrate and/or ceramic-based substrate can comprise an additional compressive stress region opposite the compressive stress region discussed above. In further embodiments, the additional compressive stress region can comprise a depth of compression within one or more of the ranges discussed above and/or a maximum compressive stress within one or more of the ranges discussed above.

In some embodiments, the first portion can comprise an optional coating at the first major surface 201 and/or second major surface 203, for example, disposed over a glass-based substrate and/or ceramic-based substrate. In some embodiments, the coating, if provided, may comprise one or more of an easy-to-clean coating, a low-friction coating, an oleophobic coating, a diamond-like coating, a scratch-resistant coating, or an abrasion resistant coating. A scratch-resistant coating may comprise an oxynitride, for example, aluminum oxynitride or silicon oxynitride with a thickness of about 500 micrometers or more. In such embodiments, the abrasion resistant layer may comprise the same material as the scratch resistant layer. In some embodiments, a low friction coating may comprise a highly fluorinated silane coupling agent, for example, an alkyl fluorosilane with oxymethyl groups pendant on the silicon atom. In such embodiments, an easy-to-clean coating may comprise the same material as the low friction coating. In other embodiments, the easy-to-clean coating may comprise a protonatable group, for example, an amine, for example, an alkyl aminosilane with oxymethyl groups pendant on the silicon atom. In such embodiments, the oleophobic coating may comprise the same material as the easy-to-clean coating. In some embodiments, a diamond-like coating comprises carbon and may be created by applying a high voltage potential in the presence of a hydrocarbon plasma. Further, the coating may be a hard-coat material that is disposed over and/or bonded to the foldable substrate. Suitable materials for an optically transparent polymeric hard-coat layer include, but are not limited to: a cured acrylate resin material, an inorganic-organic hybrid polymeric material, an aliphatic or aromatic hexafunctional urethane acrylate, a siloxane based hybrid material, and a nanocomposite material, for example, an epoxy and urethane material with nanosilicate. In some embodiments, an optically transparent polymeric hard-coat layer may consist essentially of one or more of these materials. In some embodiments, an optically transparent polymeric hard-coat layer may consist of one or more of these materials. As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulate dispersed within an organic matrix. More specifically, suitable materials for an optically transparent polymeric (OTP) hard-coat layer include, but are not limited to, a polyimide, a polyethylene terephthalate (PET), a polycarbonate (PC), a poly methyl methacrylate (PMMA), organic polymer materials, inorganic-organic hybrid polymeric materials, and aliphatic or aromatic hexafunctional urethane acrylates. In some embodiments, an OTP hard-coat layer may consist essentially of an organic polymer material, an inorganic-organic hybrid polymeric material, or aliphatic or aromatic hexafunctional urethane acrylate. In some embodiments, an OTP hard-coat layer may consist of a polyimide, an organic polymer material, an inorganic-organic hybrid polymeric material, or aliphatic or aromatic hexafunctional urethane acrylate. In some embodiments, an OTP hard-coat layer may include a nanocomposite material. In some embodiments, an OTP hard-coat layer may include a nano-silicate at least one of epoxy and urethane materials. Suitable compositions for such an OTP hard-coat layer are described in U.S. Pat. Pub. No. 2015/0110990, which is hereby incorporated by reference in its entirety by reference thereto. As used herein, “organic polymer material” means a polymeric material comprising monomers with only organic components. In some embodiments, an OTP hard-coat layer may comprise an organic polymer material manufactured by Gunze Limited and having a hardness of 9H, for example, Gunze’s “Highly Durable Transparent Film.” As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulate dispersed within an organic matrix. In some embodiments, the inorganic-organic hybrid polymeric material may include polymerized monomers comprising an inorganic silicon-based group, for example, a silsesquioxane polymer. A silsesquioxane polymer may be, for example, an alky- silsesquioxane, an aryl-silsesquioxane, or an aryl alkyl- silsesquioxane having the following chemical structure: (RSiO_{1.5})ₙ, where R is an organic group for example, but not limited to, methyl or phenyl. In some embodiments, an OTP hard-coat layer may comprise a silsesquioxane polymer combined with an organic matrix, for example, SILPLUS manufactured by Nippon Steel Chemical Co., Ltd. In some embodiments, an OTP hard-coat layer may comprise 90 wt% to 95 wt% aromatic hexafunctional urethane acrylate (e.g., PU662NT (Aromatic hexafunctional urethane acrylate) manufactured by Miwon Specialty Chemical Co.) and 10 wt% to 5 wt% photo-initiator (e.g., Darocur 1173 manufactured by Ciba Specialty Chemicals Corporation) with a hardness of 8H or more. In some embodiments, an OTP hard-coat layer composed of an aliphatic or aromatic hexafunctional urethane acrylate may be formed as a stand-alone layer by spin-coating the layer on a polyethylene terephthalate (PET) substrate, curing the urethane acrylate, and removing the urethane acrylate layer from the PET substrate. An OTP hard-coat layer may have a thickness in the range of 1 µm to 150 µm, for example from 10 µm to 140 µm, from 20 µm to 130 µm, 30 µm to 120 µm, from 40 µm to 110 µm, from 50 µm to 100 µm, from 60 µm to 90 µm, 70 µm, 80 µm, 2 µm to 140 µm, from 4 µm to 130 µm, 6 µm to 120 µm, from 8 µm to 110 µm, from 10 µm to 100 µm, from 10 µm to 90 µm, 10 µm, 80 µm, 10 µm, 70 µm, 10 µm, 60 µm, 10 µm, 50 µm, or any range or subrange therebetween. In some embodiments, an OTP hard-coat layer may be a single monolithic layer.

In some embodiments, an OTP hard-coat layer may be an inorganic-organic hybrid polymeric material layer or an organic polymer material layer having a thickness in the range of 80 µm to 120 µm, including subranges. For example, an OTP hard-coat layer comprising an inorganic-organic hybrid polymeric material or an organic polymer material may have a thickness of from 80 µm to 110 µm, 90 µm to 100 µm, or any range or subrange therebetween. In some embodiments, an OTP hard-coat layer may be an aliphatic or aromatic hexafunctional urethane acrylate material layer having a thickness in the range of 10 µm to 60 µm, including subranges. For example, an OTP hard-coat layer comprising an aliphatic or aromatic hexafunctional urethane acrylate material may have a thickness of 10 µm to 55 µm, 10 µm to 50 µm, 10 µm to 40 µm, 10 µm to 45 µm, 10 µm to 40 µm, 10 µm to 35 µm, 10 µm to 30 µm, 10 µm to 25 µm, 10 µm to 20 µm, or any range or subrange therebetween.

Foldable apparatus 101, 301, 401, 501, 601, 701, and 801 of the disclosure can comprise a first portion of the plurality of first portions comprising a polymeric-based portion, a polarizer, a touch sensor, and/or a display device (described below). In some embodiments, the polymer-based portion can comprise a rigid polymer (e.g., comprising a Young’s modulus at 23° C. of about 3 GigaPascals (GPa) or more, about 8 GPa or more, about 9 GPa or more, or about 10 GPa or more). Example embodiments of rigid polymers include but are not limited to blends, nanoparticle, and/or fiber composites of one or more of styrene-based polymers (e.g., polystyrene (PS), styrene acrylonitrile (SAN), styrene maleic anhydride (SMA)), phenylene-based polymer (e.g., polyphenylene sulfide (PPS)), polyvinylchloride (PVC), polysulfone (PSU), polyphthalmide (PPA), polyoxymethylene (POM), polylactide (PLA), polyimides (PI), polyhydroxybutyrate (PHB), polyglycolides (PGA), polyethyleneterephthalate (PET), and/or polycarbonate (PC).

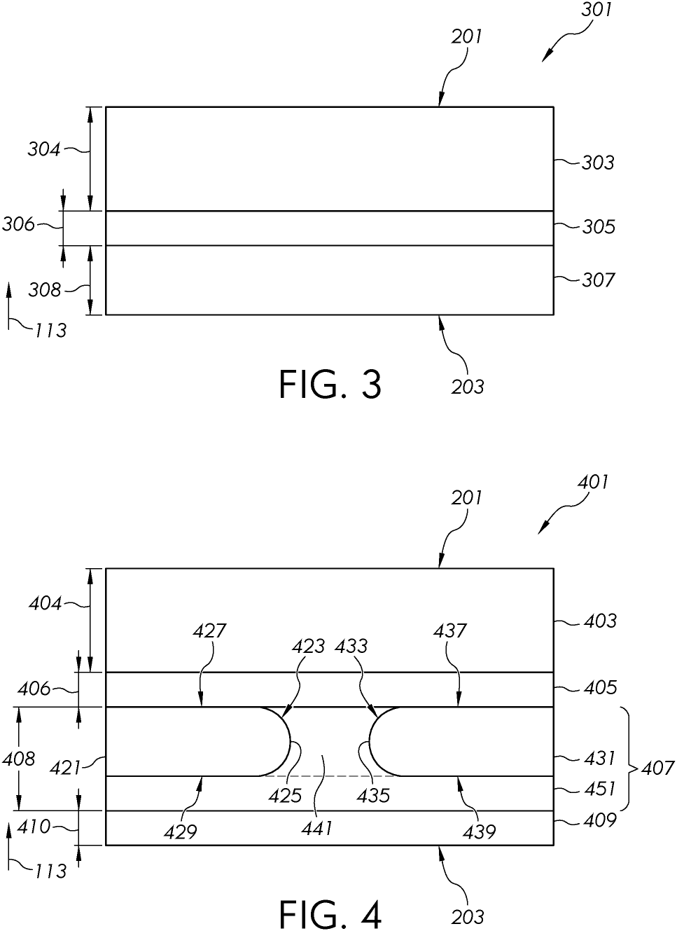

A first portion of the plurality of first portions can comprise a first thickness. For example, with reference to FIG. 3, the first portion 303 of the plurality of first portions can comprise the first thickness 304, and an another first portion 307 of the plurality of first portions can comprise an another first thickness 308. In some embodiments, the first thickness can be about 10 µm or more, about 20 µm or more, about 40 µm or more, about 60 µm or more, about 80 µm or more, about 100 µm or more, about 1 mm or less, about 800 µm or less, about 500 µm or less, about 300 µm or less, or about 200 µm or less. In further embodiments, the first thickness can be in a range from about 10 µm to about 1 mm, from about 10 µm to about 800 µm, from about 20 µm to about 800 µm, from about 40 µm to about 800 µm, from about 40 µm to about 500 µm, from about 60 µm to about 500 µm, about 80 µm to about 500 µm, from about 80 µm to about 300 µm, from about 100 µm to about 300 µm, from about 100 µm to about 200 µm, or any range or subrange therebetween.

Throughout the disclosure, a flexural rigidity of a material is the product of the Young’s modulus of the material and a cube of the thickness of the material divided by 12 times the quantity of 1 minus a square of the Poisson’s ratio of the material. As used herein, the flexural rigidity of a portion comprising multiple materials is the sum of the flexural rigidity of each of the materials. In some embodiments, a first portion of the plurality of first portions can comprise a flexural rigidity of about 10⁻⁶ Pascals meters cubed (Pa m³) or more, about 10⁻⁵ Pa m³ or more, about 10⁻⁴ Pa m³ or more, about 10⁻³ Pa m³ or more, about 0.5 Pa m³ or less, about 0.3 Pa m³ or less, about 0.1 Pa m³ or less, about 0.05 Pa m³ or less, or about 0.01 Pa m³ or less. In some embodiments, a first portion of the plurality of first portions can comprise a flexural rigidity in a range from about 10⁻⁶ Pa m³ to about 0.5 Pa m³, from about 10⁻⁵ Pa m³ to about 0.5 Pa m³, from about 10⁻⁵ Pa m³ to about 0.3 Pa m³, from about 10⁻⁴ Pa m³ to about 0.3 Pa m³, from about 10⁻⁴ Pa m³ to about 0.1 Pa m³, from about 10⁻³ Pa m³ to about 0.1 Pa m³, from about 10⁻³ Pa m³ to about 0.01 Pa m³, or any range or subrange therebetween.

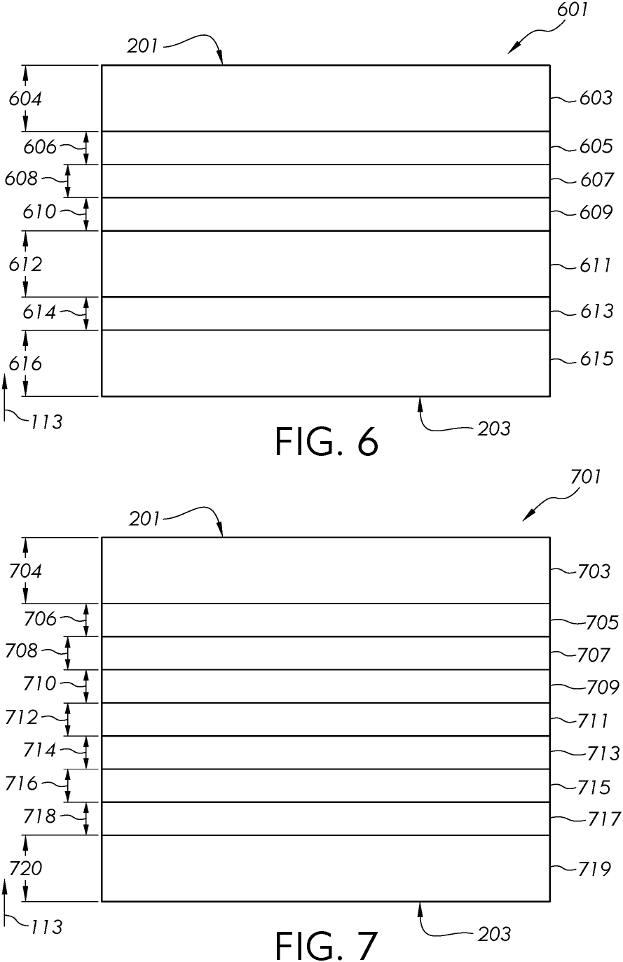

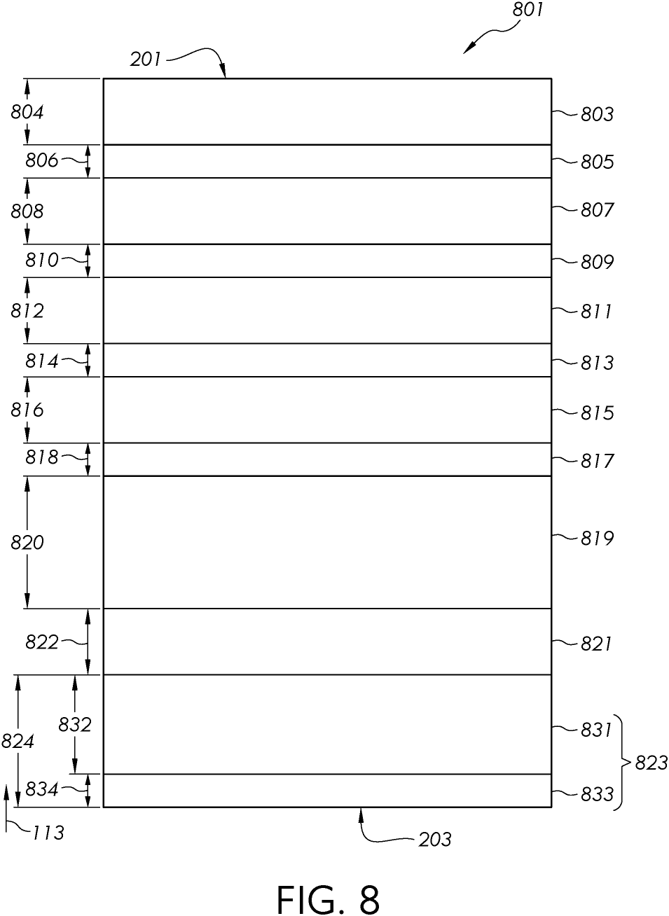

The foldable apparatus comprises at least one second portion. Throughout the disclosure, the at least one second portion can be positioned between an adj acent pair of first portions as a stack in the direction 113 of the apparatus thickness 211. For example, as shown in FIGS. 3-4, the foldable apparatus 301 or 401 can comprise one second portion 305 or 405, respectively. Further, when the at least one second portion comprises two or more second portions, as shown in FIGS. 2 and 5-8, the two or more second portions can be arranged sequentially as a stack in the direction 113 of the apparatus thickness 211. For example, as shown in FIG. 5, the foldable apparatus 501 can comprise two second portions 506 and 510. In another example, as shown in FIG. 6, the foldable apparatus 601 can comprise three second portions 605, 609, and 613. In another example, as shown in FIG. 7, the foldable apparatus 701 can comprise four second portions 705, 709, 713, and 717. In further embodiments, the foldable apparatus can comprise five or more second portions. For example, as shown in FIG. 8, the foldable apparatus 801 can comprise five second portions 805, 809, 813, 817, and 821. In further embodiments, as shown in FIGS. 2-8, a second portion of the one or more second portions can be positioned between an adjacent pair of first portions of the plurality of first portions. In even further embodiments, as shown, each second portion of the one or more second portions can be positioned between a corresponding adjacent pair of first portions of the plurality of first portions. In even further embodiments, each second portion can have at least one first portion between it and the first major surface and/or second major surface of the foldable apparatus.

In some embodiments, a second portion of the at least one second portion can comprise a Young’s modulus. In some embodiments, a second portion can comprise more than one material, as discussed below. In some embodiments, a maximum Young’s modulus of a second portion of the at least one second portion can be about 0.001 MPa or more, about 0.005 MPa or more, about 0.01 MPa or more, about 0.02 MPa or more, about 0.05 MPa or more, about 0.08 MPa or more, about 10 MPa or less, about 1 MPa or less, 0.5 MPa or less, about 0.3 MPa or less, about 0.2 MPa or less, or about 0.1 MPa or less. In some embodiments, the maximum Young’s modulus of the second portion of the at least one second portion can be in a range from about 0.001 MPa to about 10 MPa, from about 0.001 MPa to about 1 MPa, from about 0.005 MPa to about 1 MPa, from about 0.005 MPa to about 0.5 MPa, from about 0.01 MPa to about 0.5 MPa, from about 0.01 MPa to about 0.3 MPa, from about 0.02 MPa to about 0.3 MPa, from about 0.02 MPa to about 0.2 MPa, from about 0.05 MPa to about 0.2 MPa, from about 0.05 MPa to about 0.1 MPa, from about 0.08 MPa to about 0.1 MPa, or any range or subrange therebetween. In some embodiments, a maximum value of the maximum Young’s modulus of all of the second portions of the at least one second portion can be within one or more of the ranges listed above. In some embodiments, a minimum Young’s modulus of a second portion of the at least one second portion can be within one or more of the ranges discussed above for the maximum Young’s modulus of the second portion. In some embodiments, a minimum value of the minimum Young’s modulus of all of the second portions of the at least one second portion can be within one or more of the ranges listed above for the maximum Young’s modulus. It is to be understood that a second portion can comprise a minimum Young’s modulus within one or more of the ranges discussed above without a corresponding maximum Young’s modulus being within one or more of the ranges discussed above.

In some embodiments, a second portion of the at least one second portion can comprise a maximum Poisson’s ratio of about 0.20 or more, about 0.30 or more, about 0.40 or more, about 0.45 or more, about 0.49 or more, about 0.495 or more, about 0.499 or more, or about 0.50 or less. In some embodiments, a second portion of the at least one second portion can comprise a maximum Poisson’s ratio in a range from about 0.20 to about 0.50, from about 0.30 to about 0.50, from about 0.40 to about 0.50, from about 0.45 to about 0.50, from about 0.49 to about 0.50, from about 0.495 to about 0.50, from about 0.499 to about 0.50, or any range or subrange therebetween. In some embodiments, a maximum value of the maximum Poisson’s ratio of all of the second portions of the at least one second portion can be within one or more of the ranges listed above. In some embodiments, a minimum Poisson’s ratio of a second portion of the at least one second portion can be within one or more of the ranges discussed above for the maximum Poisson’s ratio of the second portion. In some embodiments, a minimum value of the minimum Poisson’s ratio of all of the second portions of the at least one second portion can be within one or more of the ranges listed above for the maximum Poisson’s ratio. Providing a second portion comprising a Poisson’s ratio near 0.5 can reduce bend-induced volume changes, which can reduce the incidence of optical distortions and/or bend-induced mechanical instabilities.

In some embodiments, a second portion of the at least one second portion can comprise an adhesive. In further embodiments, the adhesive can comprise an optically clear adhesive and/or a pressure sensitive adhesive. In further embodiments, the adhesive can comprise an optically clear adhesive comprising a polymer (e.g., optically transparent polymer). Exemplary embodiments of optically clear adhesives can comprise, but are not limited to acrylic adhesives (e.g., 3M 8212 adhesive), an optically transparent liquid adhesive (e.g., a LOCTITE optically transparent liquid adhesive), and transparent acrylics, epoxies, silicones, and polyurethanes. In some embodiments, the second portion can comprise one or more of a silicone-based polymer, an acrylate-based polymer, an epoxy-based polymer, a thiol-containing polymer, or a polyurethane. In even further embodiments, the silicone-based polymer can comprise a silicone elastomer. Exemplary embodiments of a silicone elastomer include PP2-OE50 available from Gelest and LS 8941 available from NuSil. In even further embodiments, the second portion can comprise one or more of an optically transparent: an acrylic (e.g., polymethylmethacrylate (PMMA)), an epoxy, a silicone, and/or a polyurethane. Examples of epoxies include bisphenol-based epoxy resins, novolac-based epoxies, cycloaliphatic-based epoxies, and glycidylamine-based epoxies. In further embodiments, the first material can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). Example embodiments of polyolefins include low molecular weight polyethylene (LDPE), high molecular weight polyethylene (HDPE), ultrahigh molecular weight polyethylene (UHMWPE), and polypropylene (PP). Example embodiments of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example embodiments of elastomers include rubbers (e.g., polybutadiene, polyisoprene, chloroprene rubber, butyl rubber, nitrile rubber) and block copolymers (e.g., styrene-butadiene, high-impact polystyrene, poly(dichlorophosphazene). In some embodiments, the second portion can comprise a sol-gel material. Example embodiments of polyurethanes comprise thermoset polyurethanes, for example, Dispurez 102 available from Incorez and thermoplastic polyurethanes, for example, KrystalFlex PE505 available from Huntsman. In even further embodiments, the second portion can comprise an ethylene acid copolymer. An exemplary embodiment of an ethylene acid copolymer includes SURLYN available from Dow (e.g., Surlyn PC-2000, Surlyn 8940, Surlyn 8150). An additional exemplary embodiment for the second portion comprises Eleglass w802-GL044 available from Axalta with from 1 wt% to 2 wt% cross-linker.

In some embodiments, the second portion can comprise a polymer-based material comprising a glass-transition (Tg) temperature. As used herein, the glass transition temperature, the Young’s modulus at a range of temperatures, and the Young’s modulus at a glassy plateau are measured using Dynamic Mechanical Analysis (DMA) with an instrument, for example, the DMA 850 from TA Instruments. In further embodiments, the glass transition temperature of the polymer-based material can be about 0° C. or less, about -20° C. or less, or about -40° C. or less. In further embodiments, the glass transition temperature of the polymer-based portion can be in a range from about -200° C. to about 0° C., from about -160° C. to about 0° C., from about -100° C. to about 0° C., from about -100° C. to about -20° C., from about -80° C. to about -20° C., from about -80° C. to about -40° C., or any range or subrange therebetween. In further embodiments, the glass transition temperature of the polymer-based material can be about 40° C. or more, about 50° C. or more, about 60° C. or more, or about 70° C. or more. In further embodiments, the glass transition temperature of the polymer-based portion can be in a range from about 40° C. to about 250° C., from about 50° C. to about 220° C., from about 60° C. to about 200° C., from about 60° C. to about 180° C., from about 60° C. to about 150° C., from about 60° C. to about 120° C., from about 70° C. to about 100° C., or any range or subrange therebetween. Providing a polymer-based portion with a glass transition temperature outside of an operating range (e.g., from about 0° C. to about 40° C., from about -20° C. to about 60° C.) of a foldable apparatus can enable the foldable apparatus to have consistent properties across the operating range.

In some embodiments, the second portion can remain within an elastic deformation regime. In some embodiments, the second portion can comprise a strain at yield of about 10% or more, about 50% or more, about 100% or more, about 150% or more, or about 200% or more. In some embodiments, the second portion can comprise a strain at yield in a range from about 10% to about 10,000%, from about 50% to about 5,000%, from about 100% to about 1,000%, from about 100% to about 500%, from about 100% to about 300%, from about 100% to about 200%, from about 150% to about 1,000%, from about 150% to about 500%, from about 200% to about 500%, or any range or subrange therebetween. In some embodiments, the second material can comprise one or more of a polyamide, LDPE, HDPE, PTFE, perfluoroalkoxyethylene, PVF, ETFE, polybutadiene rubber, nitrile rubber, and styrene-butadiene rubber.

In some embodiments, a second portion of the at least one second portion can comprise particles and/or nanoparticles. In further embodiments, the second portion can comprise one or more types of nanoparticles, for example, silica, alumina, kaolin, and/or hydroxyapatite. In further embodiments, the second portion can comprise one or more types of particles, for example, copper oxide, beta-quartz, a tungstate, a vanadate, a pyrophosphate, and/or a nickel-titanium alloy. In further embodiments, the second portion can comprise a low coefficient of thermal expansion (CTE) or a negative coefficient of thermal expansion. As used herein, a coefficient of thermal expansion is measured in accordance with ASTM E289-17 using a Picoscale Michelson Interferometer between -20° C. and 40° C. In even further embodiments, the second portion can comprise a CTE of about -20×10⁻⁷ 1/°C or more, about -10×10⁻⁷ 1/°C or more, about -5×10⁻⁷ 1/°C or more, about -2×10⁻⁷ 1/°C or more, about 10×10⁻⁷ 1/°C or less, about 5×10⁻⁷ 1/°C or less, about 2×10⁻⁷ 1/°C or less, about 1×10⁻⁷ 1/°C or less, or 0 1/°C or less. In even further embodiments, the second portion can comprise a CTE in a range from about -20×10⁻⁷ 1/°C to about 10×10⁻⁷ 1/°C, from about -20×10⁻⁷ 1/°C to about 5×10⁻⁷ 1/°C, from about -10×10⁻⁷ 1/°C to about -5×10⁻⁷ 1/°C, from about -10×10^{- 7} 1/°C to about 2×10⁻⁷ 1/°C, from about -10×10⁻⁷ 1/°C to 0 1/°C, from about -5×10⁻⁷ 1/°C to 0 1/°C, from about -2×10⁻⁷ 1/°C to about 0 1/°C, or any range or subrange therebetween.

A second portion of the at least one second portion can comprise a second thickness. For example, with reference to FIG. 3, the second portion 305 of the at least one second portion can comprise the second thickness 306. In some embodiments, the second thickness can be about 10 µm or more, about 25 µm or more, about 40 µm or more, about 65 µm or more, about 1 mm or less, about 500 µm or less, about 250 µm or less, about 200 µm or less, about 150 µm or less, about 125 µm or less, about 100 µm or less, or about 80 µm or less. In further embodiments, the second thickness can be in a range from about 10 µm to about 1 mm, from about 10 µm to about 500 µm, from about 10 µm to about 250 µm, from about 10 µm to about 200 µm, from about 10 µm to about 150 µm, from about 10 µm to about 125 µm, about 10 µm to about 100 µm, from about 25 µm to about 100 µm, from about 40 µm to about 100 µm, from about 65 µm to about 100 µm, from about 65 µm to about 80 µm, or any range or subrange therebetween.

In some embodiments, a second portion of the at least one second portion can comprise a flexural rigidity of about 10⁻⁹ Pa m³ or more, about 10⁻⁸ Pa m³ or more, about 10⁻⁷ Pa m³ or more, about 10⁻⁶ Pa m³ or more, about 10⁻⁴ Pa m³ or less, about 5 × 10⁻⁵ Pa m³ or less, about 10⁻⁵ Pa m³ or less, or about 5 × 10⁻⁶ Pa m³ or less. In some embodiments, a second portion of the at least one second portion can comprise a flexural rigidity in a range from about 10⁻⁹ Pa m³ to about 10⁻⁴ Pa m³, from about 10⁻⁸ Pa m³ to about 10⁻⁴ Pa m³, from about 10⁻⁸ Pa m³ to about 5 × 10⁻⁵ Pa m³, from about 10⁻⁷ Pa m³ to about 5 × 10⁻⁵ Pa m³, from about 10⁻⁷ Pa m³ to about 10⁻⁵ Pa m³, from about 10⁻⁷ Pa m³ to about 5 × 10⁻⁶ Pa m³, from about 10⁻⁶ Pa m³ to about 5 × 10⁻⁶ Pa m³, or any range or subrange therebetween. Providing a second portion comprising a low (e.g., about 10⁻⁴ Pa m³ or less) flexural rigidity can reduce bend-induced stresses in adjacent first portions, which can reduce the incidence of bend-induced mechanical instabilities.

Throughout the disclosure, the at least one second portion of the foldable apparatus is positioned between a corresponding adjacent pair of first portions of the plurality of first portions. For example, with reference to FIG. 3, the at least one second portion comprises the second portion 305 that is positioned between the adjacent pair of first portions comprising the first portion 303 and an additional first portion 307 of the plurality of first portions. As used herein, an adjacent pair of first portions means that there is only a second portion but no other first portion between the pair of first portions. For example, with reference to FIG. 3, the first portion 303 and the additional first portion 307 are an adjacent pair of first portions since there is only a second portion 305 and no first portions between the first portions 303 and 307 of the adjacent pair of first portions. For example, with reference to FIG. 6, a first portion 603 and an additional first portion 607 are an adjacent pair of first portions since there is only a second portion 605 and no first portions between the first portions 603 and 607 of the adjacent pair of first portions. In contrast, with reference to FIG. 6, a first portion 603 and a further first portion 611 are not an adjacent pair of first portions because there is an additional first portion 607 positioned between the first portions 603 and 611.

Throughout the disclosure, a first portion is an “adjacent” first portion relative to a second portion if there is no further first portion between the first portion and the second portion. For example, with reference to FIG. 6, the first portion 603 is an adjacent first portion relative to the second portion 605 because there is no further first portion between the first portion 603 and the second portion 605. Consequently, each first portion of an adjacent pair of first portions is an adjacent first portion relative to the second portion positioned therebetween. In contrast, with reference to FIG. 6, the first portion 603 is not an adjacent first portion relative to an additional second portion 609 because the additional first portion 607 is positioned between the first portion 603 and the additional second portion 609.

Throughout the disclosure, a second portion comprises a maximum Young’s modulus that is less than a minimum Young’s modulus of an adjacent first portion. Further, the maximum Young’s modulus of the second portion is at least about 500 times less than the minimum Young’s modulus of the adjacent first portion. Consequently, a prospective portion comprising a maximum Young’s modulus that is more than a minimum Young’s modulus of an adjacent first portion is treated as part of the first portion. A prospective portion comprising a maximum Young’s modulus that is less than a minimum Young’s modulus of an adjacent first portion by a multiple of less than 500 is treated as part of the first portion. A prospective portion comprising a maximum Young’s modulus that is less than a minimum Young’s modulus of an adjacent first portion by a multiple of about 500 or more is treated as a second portion, although a greater multiple may be specified in further embodiments, for example, in the next two paragraphs.

Also, a prospective portion can be classified relative to an adjacent second portion. As used herein, a second portion is adjacent to another portion if there is no other layer between the second portion and the another portion. A prospective portion comprising a minimum Young’s modulus that is less than a maximum Young’s modulus of an adjacent second portion is treated as part of the adjacent second portion. A prospective portion comprising a minimum Young’s modulus that is greater than a maximum Young’s modulus of the adjacent second portion by a multiple of less than 500 is treated as part of the adjacent second portion. A prospective portion comprising a minimum Young’s modulus that is greater than a maximum Young’s modulus of the adjacent second portion by a multiple of about 500 or more is treated as a first portion, although a greater multiple may be specified in further embodiments, for example, in the next paragraph.

In some embodiments, a maximum Young’s modulus of a second portion can be less than a minimum Young’s modulus of an adjacent first portion by a multiple of about 500 or more, about 750 or more, about 1,000 or more, about 5,000 or more, about 8,000 or more, about 10,000 or more, about 15,000 or more, about 30,000 or more, about 60,000 or more, about 500,000 or less, about 400,000 or less, about 300,000 or less, about 150,000 or less, or about 100,000 or less. In some embodiments, a maximum Young’s modulus of a second portion can be less than a minimum Young’s modulus of an adjacent first portion by a multiple in a range from about 500 to about 500,000, from about 500 to about 400,000, from about 750 to about 400,000, from about 1,000 to about 400,000, from about 1,000 to about 300,000, from about 3,000 to about 300,000, from about 5,000 to about 300,000, from about 8,000 to about 300,000, from about 8,000 to about 150,000, from about 10,000 to about 150,000, from about 0,000 to about 100,000, from about 15,000 to about 100,000, from about 30,000 to about 100,000, from about 60,000 to about 100,000, or any range or subrange therebetween. In some embodiments, each second portion can comprise a corresponding maximum Young’s modulus that is less than each first portion of the corresponding adjacent pair of first portions by a multiple of about 500 or more, about 750 or more, about 1,000 or more, about 5,000 or more, about 8,000 or more, about 10,000 or more, about 15,000 or more, about 30,000 or more, about 60,000 or more, about 500,000 or less, about 400,000 or less, about 300,000 or less, about 150,000 or less, or about 100,000 or less. In some embodiments, each second portion can comprise a corresponding maximum Young’s modulus that is less than each first portion of the corresponding adjacent pair of first portions by a multiple of about 500 or more, about 750 or more, about 1,000 or more, about 5,000 or more, about 8,000 or more, about 10,000 or more, about 15,000 or more, about 30,000 or more, about 60,000 or more, about 500,000 or less, about 400,000 or less, about 300,000 or less, about 150,000 or less, or about 100,000 or less. In some embodiments, a maximum Young’s modulus of a second portion can be less than a minimum Young’s modulus of an adjacent first portion by a multiple in a range from about 500 to about 500,000, from about 500 to about 400,000, from about 750 to about 400,000, from about 1,000 to about 400,000, from about 1,000 to about 300,000, from about 3,000 to about 300,000, from about 5,000 to about 300,000, from about 8,000 to about 300,000, from about 8,000 to about 150,000, from about 10,000 to about 150,000, from about 10,000 to about 100,000, from about 15,000 to about 100,000, from about 30,000 to about 100,000, from about 60,000 to about 100,000, or any range or subrange therebetween. Providing at least one second portion comprising a much lower (e.g., from about 500 times to about 500,000 times, from about 10,000 times to about 100,000 times) Young’s modulus than an adjacent pair of first portions can reduce bend-induced stresses on one or more of the first portions in the adjacent pair of first portions. Reducing bend-induced stresses can reduce (e.g., decreases, eliminate) bend-induced mechanical instabilities of the foldable apparatus. Also, reducing bend-induced stresses can reduce fatigue of the foldable apparatus while increasing the reliability and/or durability of the foldable apparatus.

In some embodiments, a number of second portions of the at least one second portion can be one less than a number of first portions of the plurality of first portions. In further embodiments, the number of second portions of the at least one second portion can be 1. For example, with reference to FIG. 3, the foldable apparatus 301 can comprise a one second portion 305 of the at least one second portion and two first portions 303 and 307 of the plurality of first portions. Likewise, with reference to FIG. 4, the foldable apparatus 401 can comprise a one second portion 405 of the at least one second portion and two first portions of the plurality of first portions, wherein the plurality of first portions comprises a one first portion 403 and an another first portion comprising reference numbers 407 and 409. In further embodiments, the number of second portions of the at least one second portion can be 2. For example, with reference to FIG. 5, the foldable apparatus 401 can comprise two second portions 505 and 509 of the at least one second portion and three first portions, wherein the plurality of first portions comprises a one first portion 503 comprising two first sub-portions 513 and 515, the another first portion 507 comprising two first sub-portions 517 and 519, and an additional first portion 511 comprising two first sub-portions 521 and 523. In further embodiments, the number of second portions of the at least one second portion can be 3. For example, with reference to FIG. 6, the foldable apparatus 601 can comprise three second portions 605, 609, and 613 of the at least one second portion and four first portions 603, 607, 611, and 615 of the plurality of first portions. In further embodiments, the number of second portions of the at least one second portion can be 4. For example, with reference to FIG. 7, the foldable apparatus 701 can comprise four second portions 705, 709, 713, and 717 of the at least one second portion and five first portions 703, 707, 711, 715, and 719 of the plurality of first portions. In further embodiments, the number of second portions of the at lest one second portion can be 5 or more. In even further embodiments, the number of second portion of the at least one second portion can be 5. For example, with reference to FIG. 8, the foldable apparatus 801 can comprise five second portions 805, 809, 813, 817, and 821 of the at least one second portion and six first portions 803, 807, 811, 815, 819, and 823 of the plurality of first portions, wherein first portion 823 comprises a one first sub-portion 831 and an another first sub-portion 833.

In some embodiments, a flexural rigidity of a second portion can be less than a flexural rigidity of an adjacent first portion. In further embodiments, the flexural rigidity of the second portion can be less than a flexural rigidity of the adjacent first portion by a multiple of about 1,000 or more, about 4,000 or more, about 8,000 or more, about 12,000 or more, about 16,000 or more, about 20,000 or more, about 500,000, about 250,000 or less, about 100,000 or less, about 40,000 or less, about 30,000 or less, or about 25,000 or less. In further embodiments, the flexural rigidity of the second portion can be less than a flexural rigidity of the adjacent first portion by a multiple in a range from about 1,000 to about 500,000, from about 1,000 to about 250,000, from about 1,000 to about 100,000, from about 4,000 to about 100,000, from about 4,000 to about 40,000, from about 8,000 to about 40,000, from about 12,000 to about 40,000, from about 12,000 to about 30,000, from about 16,000 to about 30,000, from about 20,000 to about 30,000, or any range or subrange therebetween. In some embodiments, each second portion can comprise a corresponding flexural rigidity that is less than the flexural rigidity of each first portion of the corresponding adjacent pair of first portions. In further embodiments, each second portion can comprise a corresponding flexural rigidity that is less than the flexural rigidity of each first portion of the corresponding adjacent pair of first portions by a multiple of about 1,000 or more, about 4,000 or more, about 8,000 or more, about 12,000 or more, about 16,000 or more, about 20,000 or more, about 500,000, about 250,000 or less, about 100,000 or less, about 40,000 or less, about 30,000 or less, or about 25,000 or less. In further embodiments, each second portion can comprise a corresponding flexural rigidity that is less than the flexural rigidity of each first portion of the corresponding adjacent pair of first portions by a multiple in a range from about 1,000 to about 500,000, from about 1,000 to about 250,000, from about 1,000 to about 100,000, from about 4,000 to about 100,000, from about 4,000 to about 40,000, from about 8,000 to about 40,000, from about 12,000 to about 40,000, from about 12,000 to about 30,000, from about 16,000 to about 30,000, from about 20,000 to about 30,000, or any range or subrange therebetween. Providing a second portion comprising a flexural rigidity of a second portion that is about 100 times or more less than a flexural rigidity of an adjacent first portion can reduce bend-induced stresses on the first portion, bend-induced mechanical instabilities in the foldable apparatus, and/or fatigue of the foldable apparatus.

Throughout the disclosure, “optically transparent” means an average transmittance of 70% or more in the wavelength range of 400 nm to 700 nm through a 1.0 mm thick piece of a material. In some embodiments, an optically transparent material may have an average transmittance of 75% or more, 80% or more, 85% or more, or 90% or more, 92% or more, 94% or more, 96% or more in the wavelength range of 400 nm to 700 nm through a 1.0 mm thick piece of the material. The average transmittance in the wavelength range of 400 nm to 700 nm is calculated by measuring the transmittance of whole number wavelengths from about 400 nm to about 700 nm and averaging the measurements. In some embodiments, the foldable apparatus 101, 301, 401, 501, 601, 701 or 801 can be optically transparent. In some embodiments, a first portion of the plurality of first portions can be optically transparent. In further embodiments, each first portion of the plurality of first portions can be optically transparent. In some embodiments, a second portion of the at least one second portion can be optically transparent. In further embodiments, each second portion of the at least one second portion can be optically transparent. In further embodiments, a second portion of the at least one second portion can comprise an adhesive layer that can be optically transparent (e.g., comprise an optically clear adhesive (OCA)).

Throughout the disclosure, an index of refraction may be a function of a wavelength of light passing through a material. Throughout the disclosure, for light of a first wavelength, an index of refraction of a material is defined as the ratio between the speed of light in a vacuum and the speed of light in the corresponding material. Without wishing to be bound by theory, an index of refraction of a material can be determined using a ratio of a sine of a first angle to a sine of a second angle, where light of the first wavelength is incident from air on a surface of the material at the first angle and refracts at the surface of the material to propagate light within the material at a second angle. The first angle and the second angle are both measured relative to a normal of a surface of the material. As used herein, the refractive index is measured in accordance with ASTM E1967-19, where the first wavelength comprises 589 nm. In some embodiments, a first index of refraction of a first portion of the plurality of first portions may be about 1 or more, about 1.3 or more, about 1.4 or more, about 1.45 or more, about 1.49 or more, about 3 or less, about 2 or less, or about 1.7 or less, about 1.6 or less, or about 1.55 or less. In some embodiments, a first index of refraction of a first portion of the plurality of first portions can be in a range from about 1 to about 3, from about 1 to about 2 from about 1 to about 1.7, from about 1.3 to about 1.7, from about 1.4 to about 1.7, from about 1.4 to about 1.6, from about 1.45 to about 1.55, from about 1.49 to about 1.55, or any range or subrange therebetween.

In some embodiments, a second portion of the at least one second portion can comprise a second index of refraction. In further embodiments, the second portion of the at least one second portion can comprise an index of refraction in one or more of the ranges discussed above with regards to the first index of refraction of the first portion. In further embodiments, an magnitude of the difference between the first index of refraction of the first portion of the plurality of first portions and the second index of refraction of the second portion of the at least one second portion can be about 0.1 or less, about 0.07 or less, about 0.05 or less, about 0.03 or less, about 0.001 or more, about 0.01 or more, or about 0.02 or more. In further embodiments, the differential is in a range from about 0.001 to about 0.1, from about 0.001 to about 0.07, from about 0.01 to about 0.07, from about 0.01 to about 0.05, from about 0.02 to about 0.05, from about 0.01 to about 0.02, or any range or subrange therebetween. In some embodiments, the second index of refraction may be greater than or less than the first index of refraction.

In some embodiments, the second portion comprising the second refractive index can be positioned between an adjacent pair of first portions, and an adjacent pair of first portion can comprise the first refractive index. In further embodiments, a magnitude of a difference between the second index of refraction of the second portion and the first index of refraction of the adjacent first portion can be within one or more of the ranges discussed above for the absolute difference between the first refractive index and the second refractive index. Providing a second index of refraction that substantially matches a first index of refraction of an adjacent first can reduce (e.g., mitigate, avoid) optical distortions that may otherwise occur with a mismatched index of refraction.

FIGS. 9-10 schematically illustrate example embodiments of the foldable apparatus 901 in accordance with embodiments of the disclosure in the folded configuration. In some embodiments, as shown in FIG. 10 the foldable apparatus 901 can be folded such that the first major surface 201 is on the inside of the folded foldable apparatus 901 while the second major surface 203 is on the outside of the folded foldable apparatus 901. In further embodiments, the another first portion 409 on the outside of the folded foldable apparatus 901 can comprise a display device that can be on the outside of the folded foldable apparatus 901 such that a user would view the display device through the first portion 403 and, thus, would be positioned on the side of the first major surface 201 and viewing from the side of the first major surface 201. In further embodiments, the first portion 403 on the inside of the folded foldable apparatus 901 can comprise a display device that can be on the inside of the folded foldable apparatus 901 such that a user would view the display device through the another first portion 409 and, thus, would be positioned on the side of the second major surface 203 and viewing from the side of the second major surface 203. In some embodiments, although not shown, the folded foldable apparatus can be folded such that the second major surface is on the inside of the folded foldable apparatus while the first major surface is on the outside of the folded foldable apparatus.

In some embodiments, the foldable apparatus 101, 301, 401, 501, 601, 701, and 801 may be substantially symmetric about a plane (e.g., see plane 109 in FIG. 1). As further illustrated, in some embodiments, the plane 109 may comprise the fold axis 102 of the foldable apparatus. In some embodiments, the foldable apparatus can be folded in a direction 111 (e.g., see FIG. 1) about the fold axis 102 to form a folded configuration (e.g., see FIGS. 9-10). As shown, the foldable apparatus may include a single fold axis to allow the foldable apparatus to comprise a bifold wherein, for example, the foldable apparatus may be folded in half. In further embodiments, the foldable apparatus may include two or more fold axes. For example, providing two fold axes can allow the foldable apparatus to comprise a trifold.

As used herein, “foldable” includes complete folding, partial folding, bending, flexing, or multiple capabilities. As used herein, the terms “fail,” “failure” and the like refer to breakage, destruction, delamination, or crack propagation. A foldable substrate achieves an effective bend radius of “X,” or has an effective bend radius of “X,” or comprises an effective bend radius of “X” if it resists failure when the substrate is held at an effective minimum bend radius of “X” for 24 hours at about 60° C. and about 90% relative humidity.

As used herein, the “effective minimum bend radius” of a foldable apparatus is measured with the following test configuration and process using a parallel plate apparatus 1001 (see FIG. 10) that comprises a pair of parallel rigid stainless-steel plates 1003, 1005 comprising a first rigid stainless-steel plate 1003 and a second rigid stainless-steel plate 1005. The foldable apparatus is placed between the pair of parallel rigid stainless-steel plates 1003, 1005 such that a display device, if present, is on the outside of the bend, similar to the configuration shown in FIG. 10 (e.g., when the another first portion 409 comprises a display device). The distance between the parallel plates is reduced at a rate of 50 µm/second until the parallel plate distance 1011 is equal to twice the “effective minimum bend radius” to be tested. Then, the parallel plates are held at twice the effective minimum bend radius to be tested for 24 hours at about 60° C. and about 90% relative humidity. As used herein, the “effective minimum bend radius” is the smallest effective bend radius that the foldable apparatus can withstand without failure under the conditions and configuration described above.

In some embodiments, the foldable apparatus 101, 301, 401, 501, 601, 701, or 801 can achieve an effective minimum bend radius of 100 mm or less, 50 mm or less, 20 mm or less, or 10 mm or less. In further embodiments, the foldable apparatus 101, 301, 401, 501, 601, 701, or 801 can achieve an effective bend radius of 10 millimeters (mm), or 7 mm, or 5 mm, or of 1 mm. In some embodiments, the foldable apparatus 101, 301, 401, 501, 601, 701, or 801 can comprise an effective minimum bend radius of about 10 mm or less, about 7 mm or less, about 5 mm or less, about 1 mm or more, about 2 mm or more, or about 5 mm or more. In some embodiments, the foldable apparatus 101, 301, 401, 501, 601, 701, or 801 can comprise an effective minimum bend radius in a range from about 1 mm to about 10 mm, from about 1 mm to about 7 mm, from about 1 mm to about 5 mm, from about 2 mm to about 10 mm, from about 2 mm to about 7 mm, from about 2 mm to about 5 mm, from about 5 mm to about 10 mm, from about 5 mm to about 7 mm, from about 7 mm to about 10 mm or any range or subrange therebetween.

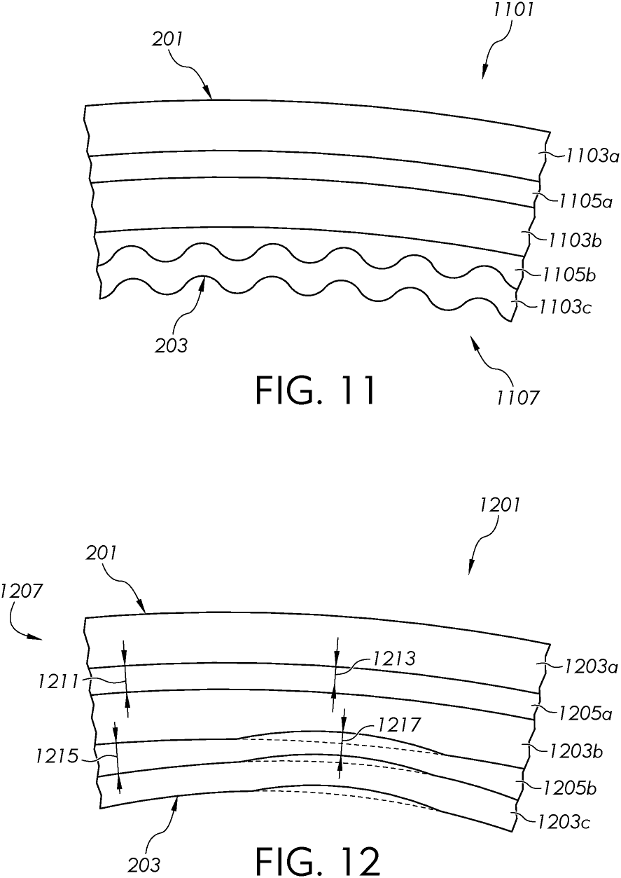

Embodiments of the disclosure can reduce (e.g., mitigate, avoid) instabilities of foldable apparatus during folding the foldable apparatus. For example, with reference to FIG. 11, a first instability 1107 is visible at the second major surface 203 of the foldable apparatus 1101. As shown, the foldable apparatus can comprise five layers (e.g., portions) comprising three layers 1103a, 1103b, and 1103c with a Young’s modulus greater than the other two layers 1105a and 1105b. In this example, an outer layer 1103c at the second major surface 203 of the foldable apparatus 1101 exhibits wrinkling. Without wishing to be bound by theory, wrinkling can be caused by variations in the local stress experienced by the outer layer 1103c, where the bend-induced strain (e.g., in-plane strain relative to the second major surface 203) exceeds a critical strain that the outer layer 1103c can withstand. Without wishing to be bound by theory, wrinkling can be the result of stress coupling (e.g., not decoupled) between adjacent layers and/or an adjacent pair of layers (e.g., 1103b and 1103c) with a Young’s modulus greater than another layer 1105b positioned therebetween.

For example, with reference to FIG. 12, a second instability 1207 is exhibited by a first inner layer 1205a of a foldable apparatus 1201. As shown, the foldable apparatus can comprise five layers (e.g., portions) comprising three layers 1203a, 1203b, and 1203c with a Young’s modulus greater than the other two layers 1205a and 1205b. In this example, the first inner layer 1205a exhibits thinning. As shown in FIG. 12, the solid lines deviate from the dashed lines, which represent the profile of the foldable apparatus 1201 without the instability 1207. For example, a first thickness 1211 of the first inner layer 1205a is greater than a second thickness 1213 of the first inner layer 1205a. Further, a second inner layer 1205b can comprise a first thickness 1215 of the second inner layer 1205b that is greater than a second thickness 1217 of the second inner layer 1205b. Thinning of the first inner layer 1205a and/or second inner layer 1205b at a location comprising the second thickness 1213 or 1217, respectively, can cause optical distortions and/or contribute to failure of the foldable apparatus 1201 in subsequent folding events. Without wishing to be bound by theory, thinning of an inner layer 1205a and/or 1205b can be caused by variations in the local stress experienced by the corresponding inner layer, where the bend-induced exceeds a critical strain that the corresponding inner layer can withstand.

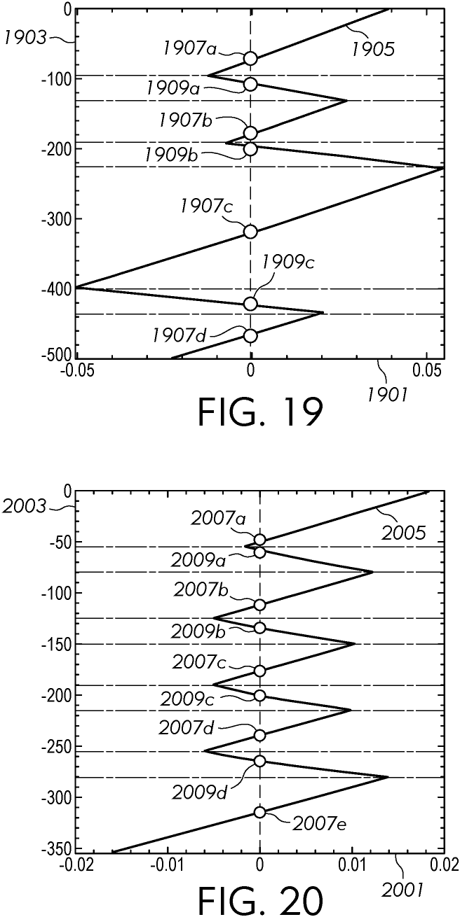

Throughout the disclosure, a neutral plane is a series of locations comprising substantially 0 strain when the foldable apparatus is folded in direction 111 (see FIG. 1). In some embodiments, where the foldable apparatus comprises a plurality of layers with each layer being substantially homogenous, a neutral plane of the foldable apparatus can comprise a plane extending substantially parallel to the first major surface 201 and/or second major surface 203 when the foldable apparatus is in an unfolded (e.g., flat) configuration. In further embodiments, the foldable apparatus can comprise a plurality of neutral planes that are each substantially parallel to the first major surface 201 and/or second major surface 203 when the foldable apparatus is in an unfolded (e.g., flat) configuration. As used herein, a first neutral plane is a neutral plane where a first region closer to the first major surface relative to the neutral plane is positive (e.g., corresponding to tensile stress) and a second region closer to the second major surface relative to the neutral plane is negative (e.g., corresponding to compressive stress). In some embodiments, a first portion can comprise a first neutral plane. In further embodiments, each first portion of the plurality of first portions can comprise a first neutral plane. As discussed in more detail below with regards to Examples B, D-F, and H, each first portion can comprise its own first neutral plane. For example, with reference to FIGS. 4 and 16, the foldable apparatus 401 can comprise two first portions 403 and 407 with a first neutral plane 1607a within the one first portion 403 and an another first neutral plane 1607b within the another first portion 407. In another example, with reference to FIGS. 5 and 18, the foldable apparatus 501 can comprise three first portions 503, 507, and 511 with a first neutral plane 1807a within a one first portion 503, an another first neutral plane 1807b within the another first portion 507, and an additional first neutral plane 1807c within the additional first portion 511. In another example, with reference to FIGS. 6 and 19, the foldable apparatus 601 can comprise four first portions 603, 607, 611, and 615 with a first neutral plane 1907a within a one first portion 603, the another first neutral plane 1907b within the another first portion 607, an additional first neutral plane 1907c within an additional first portion 611, and a further first neutral plane 1907d within a further first portion 615. In another example, with reference to FIGS. 7 and 20, the foldable apparatus 701 can comprise five first portions 703, 707, 711, 715, and 719 with a first neutral plane 2007a within a one first portion 703, an another first neutral plane 2007b within the another first portion 707, an additional first neutral plane 2007c within an additional first portion 711, a further first neutral plane 2007d within a further first portion 715, and a yet another first neutral plane 2007e within a yet another first portion 719. For example, with reference to FIGS. 8 and 22, the foldable apparatus 801 can comprise six first portions 803, 807, 811, 815, 819, and 823 with a first neutral plane 2207a within a one first portion 803, an another first neutral plane 2207b within the another first portion 807, an additional first neutral plane 2207c within an additional first portion 811, and a further first neutral plane 2207d within a further first portion 815, a yet another first neutral plane 2207e within a yet another first portion 819, and a still another first neutral plane 2207f within a still another first portion 823. In some embodiments, the foldable apparatus can comprise six or more first portions of the plurality of first portions, a number of first neutral planes equal to the number of first portions, and each first neutral plane positioned in a corresponding first portion.

As used herein, a second neutral plane is a neutral plane where a first region closer to the first major surface relative to the neutral plane is negative (e.g., corresponding to compressive stress) and a second region closer to the second major surface relative to the neutral plane is positive (e.g., corresponding to tensile stress). In some embodiments, a second portion can comprise a second neutral plane. In further embodiments, each second portion of the plurality of first portions can comprise a second neutral plane. As discussed in more detail below with regards to Examples B, D-F, and H, each first portion can comprise its own first neutral plane. For example, with reference to FIGS. 4 and 16, the foldable apparatus 401 can comprise a second portion 405 with a second neutral plane 1609a within the one second portion 405. In another example, with reference to FIGS. 5 and 18, the foldable apparatus 501 can comprise two second portions 505 and 509 with a second neutral plane 1809a within a one second portion 505 and an another second neutral plane 1809b within the another second portion 509. In another example, with reference to FIGS. 6 and 19, the foldable apparatus 601 can comprise three second portions 605, 609, and 613 with a second neutral plane 1909a within a one second portion 605, an another second neutral plane 1909b within an another second portion 609, and an additional second neutral plane 1909c within an additional second portion 613. In another example, with reference to FIGS. 7 and 20, the foldable apparatus 701 can comprise four second portions 705, 709, 713, and 717 with a second neutral plane 2009a within a one second portion 705, an another second neutral plane 2009b within an another second portion 709, an additional second neutral plane 2009c within an additional second portion 713, and a further second neutral plane 2009d within a further second portion 717. In another example, with reference to FIGS. 8 and 22, the foldable apparatus 801 can comprise five second portions 805, 809, 813, 817, and 821 with a second neutral plane 2209a within a one second portion 805, an another second neutral plane 2209b within an another second portion 809, an additional second neutral plane 2209c within an additional second portion 813, and a further second neutral plane 2209d within a further second portion 817, and a yet another second neutral plane 2209e within the yet another second portion 821. In some embodiments, the foldable apparatus can comprise five or more second portions of the at least one second portions, a number of second neutral planes equal to the number of second portions, and each second neutral plane positioned in a corresponding second portion.

In some embodiments, the foldable apparatus can comprise a plurality of first neutral planes and at least one second neutral plane. In further embodiments, a number of first neutral planes of the plurality of first neutral planes can be equal to a number of first portions of the plurality of first portions, and a number of second neutral planes of the at least one second neutral plane can be equal to a number of second portions of the at least one second portion. In further embodiments, each first portion of the plurality of first portions can comprise a first neutral plane, and each second portion of the at least one second portion can comprise a second neutral plane. In further embodiments, the foldable apparatus can comprise six or more first portions, a corresponding number of first neutral planes, five or more second portions, and a corresponding number of second neutral planes. For example, with reference to FIGS. 8 and 22, the foldable apparatus 801 can comprise six first portions 803, 807, 811, 815, and 819, a corresponding number (six) first neutral planes 2207a, 2207b, 2207c, 2207d, 2207e, and 2207f, five second portions 805, 809, 813, and 817, and a corresponding number (five) second neutral planes 2209a, 2209b, 2209c, 2209d, and 2209e. Providing a foldable apparatus where each first portion comprises a first neutral plane and each second portion comprises a second neutral plane can reduce bend-induced stresses within the first portions and at least one second portion. As discussed above, reduced bend-induced stresses can reduce bend-induced mechanical instabilities in the foldable apparatus and/or fatigue of the foldable apparatus.

The foldable apparatus may have an impact resistance defined by the capability of the first major surface 201 of the foldable apparatus 101, 301, 401, 501, 601, 701, or 801 to avoid failure at a pen drop height (e.g., 8 centimeters (cm) or more), when measured according to the “Pen Drop Test.” As used herein, the “Pen Drop Test” is conducted such that samples of foldable apparatus are tested with the load (i.e., from a pen dropped from a certain height) imparted to a second major surface of the foldable substrate configured as in the parallel plate test with 100 µm thick layer of PET attached using a 50 µm thick optically clear adhesive disposed on the second major surface 203 of the foldable apparatus 101, 301, 401, 501, 601, 701, or 801. It is to be understood that 100 µm thick layer of PET attached using a 50 µm thick optically clear adhesive in the Pen Drop Test is used instead of the optically clear adhesive and display device that the foldable apparatus may be used in combination with as part of a consumer electronic product in accordance with the embodiments of the disclosure. As such, the PET layer in the Pen Drop Test is meant to simulate a flexible electronic display device (e.g., an OLED device). For samples comprising a display device, the 50 µm thick optically clear adhesive and 100 µm thick layer of PET is omitted. During testing, the foldable substrate bonded to the PET layer is placed on an aluminum plate (6063 aluminum alloy, as polished to a surface roughness with 400 grit paper) with the PET layer in contact with the aluminum plate. No tape is used on the side of the sample resting on the aluminum plate.

A tube is used for the Pen Drop Test to guide a pen to the first major surface 201 of the foldable apparatus 101, 301, 401, 501, 601, 701, or 801, and the tube is placed in contact with the first major surface 201 of the foldable apparatus 101, 301, 401, 501, 601, 701, or 801 so that the longitudinal axis of the tube is substantially perpendicular to the first major surface 201 with the longitudinal axis of the tube extending in the direction of gravity. The tube has an outside diameter of 1 inch (2.54 cm), an inside diameter of nine-sixteenths of an inch (1.4 cm) and a length of 90 cm. An acrylonitrile butadiene (ABS) shim is employed to hold the pen at a predetermined height for each test. After each drop, the tube is relocated relative to the sample to guide the pen to a different impact location on the sample. The pen employed in Pen Drop Test is a BIC Easy Glide Pen, Fine, having a tungsten carbide ballpoint tip of 0.7 mm (0.68 mm) diameter, and a weight of 5.73 grams (g) including the cap (4.68 g without the cap).

For the Pen Drop Test, the pen is dropped with the cap attached to the top end (i.e., the end opposite the tip) so that the ballpoint can interact with the test sample. In a drop sequence according to the Pen Drop Test, one pen drop is conducted at an initial height of 1 cm, followed by successive drops in 0.5 cm increments up to 20 cm, and then after 20 cm, 2 cm increments until failure of the test sample. After each drop is conducted, the presence of any observable fracture, failure, or other evidence of damage to the sample is recorded along with the particular pen drop height. Using the Pen Drop Test, multiple samples can be tested according to the same drop sequence to generate a population with improved statistical accuracy. For the Pen Drop Test, the pen is to be changed to a new pen after every 5 drops, and for each new sample tested. In addition, all pen drops are conducted at random locations on the sample at or near the center of the sample, with no pen drops near or on the edge of the samples.

For purposes of the Pen Drop Test, “failure” means the formation of a visible mechanical defect in a laminate. The mechanical defect may be a crack or plastic deformation (e.g., surface indentation). The crack may be a surface crack or a through crack. The crack may be formed on an interior or exterior surface of a laminate. The crack may extend through all or a portion of a first portion at the surface (e.g., first major surface 201) of the foldable apparatus. A visible mechanical defect has a minimum dimension of 0.2 millimeters or more.

In some embodiments, the foldable apparatus 101, 301, 401, 501, 601, 701, or 801 can resist failure for a pen drop at a pen drop height of 10 centimeters (cm), 12 cm, 14 cm, 16 cm, or 20 cm. In some embodiments, a maximum pen drop height that the foldable apparatus can withstand without failure may be about 10 cm or more, about 12 cm or more, about 14 cm or more, about 16 cm or more, about 40 cm or less, or about 30 cm or less, about 20 cm or less, about 18 cm or less. In some embodiments, a maximum pen drop height that the foldable apparatus can withstand without failure can be in a range from about 10 cm to about 40 cm, from about 12 cm to about 40 cm, from about 12 cm to about 30 cm, from about 14 cm to about 30 cm, from about 14 cm to about 20 cm, from about 16 cm to about 20 cm, from about 18 cm to about 20 cm, or any range or subrange therebetween.

A minimum force may be used to achieve a predetermined parallel plate distance with the foldable apparatus. The parallel plate apparatus of FIG. 10, described above, is used to measure the “bend force” of a foldable apparatus or a portion of a foldable apparatus of the embodiments of the disclosure. The force to go from a flat configuration (e.g., see FIG. 1) to a bent (e.g., folded) configuration (e.g., see FIG. 10) comprising the predetermined parallel plate distance is measured. In some embodiments, an apparatus bend force comprising the minimum force to bend the foldable apparatus from a flat configuration to a parallel plate distance of 10 mm can be about 20 Newtons (N) or less, 15 N or less, about 12 N or less, about 10 N or less, about 0.1 N or more, about 0.5 N or more, about 1 N or more, about 2 N or more, about 5 N or more. In some embodiments, the apparatus bend force comprising the minimum force to bend the foldable apparatus from a flat configuration to a parallel plate distance of 10 mm can be in a range from about 0.1 N to about 20 N, from about 0.5 N to about 20 N, from about 0.5 N to about 15 N, from about 1 N to about 15 N, from about 1 N to about 12 N, from about 2 N to about 12 N, from about 2 N to about 10 N, from about 5 N to about 10 N, or any range or subrange therebetween. In some embodiments, the apparatus bend force comprising the minimum force to bend the foldable apparatus from a flat configuration to a parallel plate distance of 3 mm can be about 10 N or less, about 8 N or less, about 6 N or less, about 4 N or less, about 3 N or less, about 0.05 N or more about 0.1 N or more, about 0.5 N or more, about 1 N or more, about 2 N or more, about 3 N or more. In some embodiments, the apparatus bend force comprising the minimum force to bend the foldable apparatus from a flat configuration to a parallel plate distance of 3 mm can be in a range from about 0.05 N to about 10 N, from about 0.1 N to about 10 N, from about 0.1 N to about 8 N, from about 0.5 N to about 8 N, from about 0.5 N to about 6 N, from about 1 N to about 6 N, from about 1 N to about 4 N, from about 2 N to about 4 N, from about 2 N to about 3 N, or any range or subrange therebetween.

As used herein, a “total bend force” is a sum of a force to bend each first portion of the plurality of first portions individually and the at least one second portion individually. For example, with reference to FIG. 3, the total bend force would be the sum of bend forces for (1) a one first portion 303, (2) the second portion 305, and (3) the another first portion 307. In some embodiments, the total bend force to bend each portion of a foldable apparatus individually from a flat configuration to a parallel plate distance of 10 mm can be about 30 N or less, 25 N or less, about 20 N or less, about 15 N or less, about 0.1 N or more, about 0.5 N or more, about 1 N or more, about 5 N or more, about 10 N or more. In some embodiments, the total bend force to bend each portion of a foldable apparatus from a flat configuration to a parallel plate distance of 10 mm can be in a range from about 0.1 N to about 30 N, from about 0.1 N to about 25 N, from about 0.5 N to about 25 N, from about 0.5 N to about 20 N, from about 1 N to about 20 N, from about 1 N to about 15 N, from about 5 N to about 15 N, from about 10 N to about 15 N, or any range or subrange therebetween.

In some embodiments, the total bend force to bend each portion of a foldable apparatus from a flat configuration to a parallel plate distance of 3 mm can be about 20 N or less, about 16 N or less, about 12 N or less, about 8 N or less, about 6 N or less, about 0.05 N or more about 0.1 N or more, about 0.5 N or more, about 1 N or more, about 2 N or more, about 4 N or more. In some embodiments, the total bend force to bend each portion of a foldable apparatus from a flat configuration to a parallel plate distance of 3 mm can be in a range from about 0.05 N to about 20 N, from about 0.1 N to about 16 N, from about 0.1 N to about 16 N, from about 0.5 N to about 16 N, from about 0.5 N to about 12 N, from about 1 N to about 12 N, from about 1 N to about 8 N, from about 2 N to about 8 N, from about 4 N to about 8 N, from about 4 N to about 6 N, or any range or subrange therebetween.

In some embodiments, an apparatus bend force can be less than a total bend force comprising a force to bend each first portion of the plurality of first portions individually and the at least one second portion individually. In some embodiments, an apparatus bend force as a multiple of a total bend force comprising a force to bend each first portion of the plurality of first portions individually and the at least one second portion individually can be about 0.5 times or more, about 0.6 times or more, about 0.75 times or more about 0.8 or more, about 1 or less, about 0.95 or less, about 0.9 or less, or about 0.85 or less. In some embodiments, an apparatus bend force as a multiple of a total bend force comprising a force to bend each first portion of the plurality of first portions individually and the at least one second portion individually can be in a range from about 0.5 times to about 1 times, from about 0.6 times to about 1 times, from about 0.6 times to about 0.95 times, from about 0.75 times to about 0.95 times, from about 0.75 times to about 0.9 times, from about 0.8 times to about 0.9 times, from about 0.8 to about 0.85 times, or any range or subrange therebetween. Providing a foldable apparatus with an apparatus bend force near (e.g., within a factor of 2, from about 0.5 times to about 1 times) a total bend total bend force from bending each first portion individually can enable low user-applied forces to fold the foldable apparatus. Also, this can reflect a decreased coupling of bend-induced stresses between adjacent pairs of first portions.

In some embodiments, the foldable apparatus can comprise a display device. In further embodiments, the display device can comprise a first portion of the plurality of first portions. The display device can comprise liquid crystal display (LCD), an electrophoretic displays (EPD), an organic light emitting diode (OLED) display, or a plasma display panel (PDP). In some embodiments, the display device can be part of a portable electronic device, for example, a smartphone, a tablet, a wearable device, or a laptop.

Embodiments of the disclosure can comprise a consumer electronic product. The consumer electronic product can comprise a front surface, a back surface and side surfaces. The consumer electronic product can further comprise electrical components at least partially within the housing. The electrical components can comprise a controller, a memory, and a display. The display can be at or adjacent the front surface of the housing. The consumer electronic product can comprise a cover substrate disposed over the display. In some embodiments, at least one of a portion of the housing or the cover substrate comprises the foldable apparatus discussed throughout the disclosure.

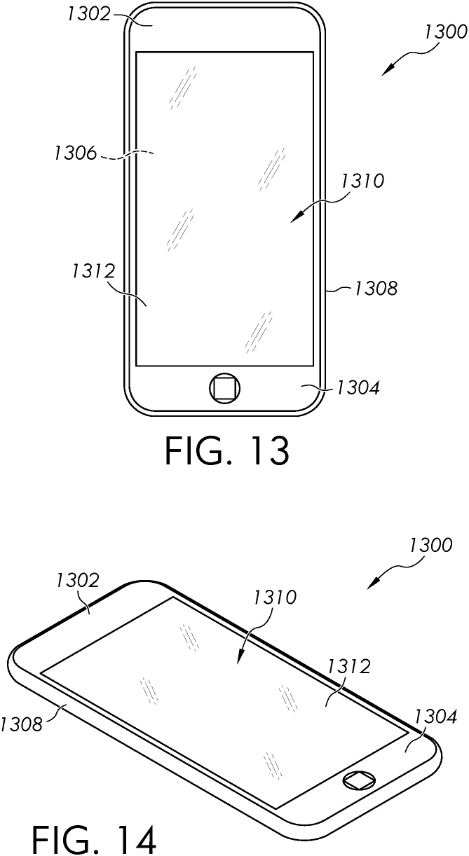

The foldable apparatus disclosed herein may be incorporated into another article, for example, an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the foldable apparatus disclosed herein is shown in FIGS. 13 and 14. Specifically, FIGS. 13 and 14 show a consumer electronic device 1300 including a housing 1302 having front 1304, back 1306, and side surfaces 1308; electrical components (not shown) that are at least partially inside or entirely within the housing and including at least a controller, a memory, and a display 1310 at or adjacent to the front surface of the housing; and a cover substrate 1312 at or over the front surface of the housing such that it is over the display. In some embodiments, at least one of the cover substrate 1312 or a portion of housing 1302 may include any of the foldable apparatus disclosed herein.

### EXAMPLES

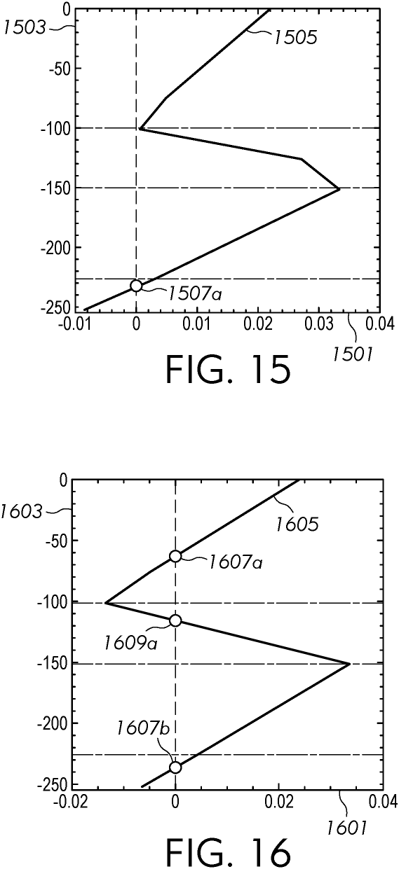

Various embodiments will be further clarified by the following examples. Examples A-H all comprise foldable apparatus comprising a plurality of layers, which in some embodiments, can be part of a first portion or second portion. Examples B, D-F, and H correspond to embodiments of the disclosure while Examples A, C, and G are comparative examples. FIGS. 15-22 comprise a horizontal axis 1501, 1601, 1701, 1801, 1901, 2001, 2101, and 2201 (e.g., x-axis) of strain, a vertical axis 1503, 1603, 1703, 1803, 1903, 2003, 2103, and 2203 (e.g., y-axis) of position from the first major surface 201, and show curves 1505, 1605, 1705, 1805, 1905, 2005, 2105, and 2205 corresponding to examples A-H, respectively. The curves 1505, 1605, 1705, 1805, 1905, 2005, 2105, and 2205 shown in FIGS. 15-22 were generated by numerical simulation; however, the ability of Examples A-H to withstand bending with (or without) mechanical instabilities (e.g., wrinkling, buckling) is based on experimental testing of the corresponding Example.

Examples A-B resemble the foldable apparatus 401 shown in FIG. 4 with properties shown in Tables 1-2, respectively. In Example A, portion 405 comprises a Young’s modulus of 0.5 MPa. As shown in FIG. 15, the foldable apparatus comprises a single first neutral axis 1507a. Example A exhibited wrinkling (see FIG. 11) at a parallel plate distance of 34 mm. In Example A, the Young’s modulus of portion 405 (e.g., maximum Young’s modulus of portion 405) is 200 times less than the Young’s modulus of sub-portions 441 and 451 (e.g., minimum Young’s modulus of portion 407). Likewise, the maximum Young’s modulus of portion 407 (71,000 MPa) is equal to the minimum Young’s modulus of portion 409. Consequently, portions 405, 407, and 409 are all the same portion type (e.g., first, second). This means that either (i) Example A comprises 2 first portions without a second portion - rather than one or more second portions - or (ii) Example A comprises 1 first portion - rather than a plurality of first portions - and the second major surface 203 comprises a second portion - rather than at least one first portion being positioned between the second portion and the first major surface 201 and second major surface 201.

In contrast to Example A, portion 405 of Example B comprises a Young’s modulus of 0.05 MPa instead of 0.5 MPa. In Example B, the Young’s modulus of portion 405 (e.g., maximum Young’s modulus of portion 405) is more than 500 times, 750 times, 1,000 times, and 1,500 times (2,000 times) less than the Young’s modulus of sub-portions 441 and 451 (e.g., minimum Young’s modulus of portion 407). Consequently, Example B comprises two first portions and a second portion, where a one first portion comprises first portion 403, the another first portion comprises portions 407 and 409, and the second portion comprises second portion 405. Example B comprises two first neutral planes 1607a and 1607b and a second neutral plane 1609a, where the one first portion 403 comprises a one first neutral plane 1607a, the another first portion 407 comprises the another first neutral plane 1607b, and the second portion 405 comprises a second neutral plane 1609a. Example B was able to withstand bending to a parallel plate distance of 6 mm without any mechanical instability.

TABLE 1

Properties of Example A corresponding to FIG. 15 .

| Portion | Sub-Portion | Young’s Modulus (MPa) | Thickness (µm) | Poisson’s Ratio | Thickness Label |
|---|---|---|---|---|---|
| 403 | | 5,400 | 100 | 0.30 | 404 |
| 405 | | 0.5 | 50 | 0.495 | 406 |
| 407 | 421, 431 | 71,000 | 30 | 0.35 | 408 |
| | 441, 451 | 100 | 75 | 0.22 | |
| 409 | | 71,000 | 30 | 0.22 | 410 |

TABLE 2

Properties of Example B corresponding to FIG. 16 .

| Portion | Sub-Portion | Type | Young’s Modulus (MPa) | Thickness (µm) | Poisson’s Ratio | Thickness Label |
|---|---|---|---|---|---|---|
| 403 | | 1 | 5,400 | 100 | 0.30 | 404 |
| 405 | | 2 | 0.05 | 50 | 0.495 | 406 |
| 407 | 421, 431 | 1 | 71,000 | 30 | 0.35 | 408 |
| | 441, 451 | | 100 | 75 | 0.22 | |
| 409 | | | 71,000 | 30 | 0.22 | 410 |

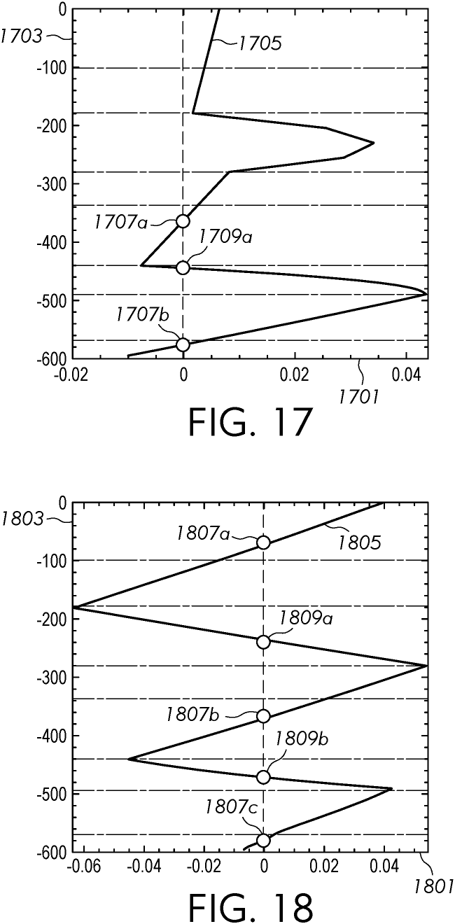

Examples C-D resemble the foldable apparatus 501 shown in FIG. 5 with properties shown in Tables 3-4, respectively. In Example C, portions 505 and 509 comprises a Young’s modulus of 0.1 MPa. As shown in FIG. 17, the foldable apparatus comprises two first neutral axes 1707a and 1707b and a single second neutral axis 1709a. Example C exhibited wrinkling (see FIG. 11) at a parallel plate distance of 100 mm.

In Example C, the Young’s modulus of portion 509 (e.g., maximum Young’s modulus of portion 509) is 1,000 times less than the Young’s modulus of sub-portions 521 and 523 (e.g., minimum Young’s modulus of portion 511). Consequently, portions 509 and 511 are the same portion type (e.g., first, second). This means that in Example C either (i) the number of first portions is three since portions 509 and 511 comprise a first portion but that there is only one second portion - rather than one less than the number of first portions, namely two - or (ii) the number of first portions is equal to the number of second portions and a second portion comprising portions 509 and 511 comprises the second major surface 203 - rather than at least one first portion being positioned between the second portion and the first major surface 201 and second major surface 201.

In contrast to Example C, portions 505 and 509 of Example D comprises a Young’s modulus of 0.01 MPa instead of 0.1 MPa. In Example B, the Young’s modulus of portion 509 (e.g., maximum Young’s modulus of portion 509) is more than 500 times, 750 times, 1,000 times, 1,500 times, and 5,000 times (10,000 times) less than the Young’s modulus of sub-portions 521 and 523 (e.g., minimum Young’s modulus of portion 511). Consequently, Example D comprises three first portions and two second portion, where a one first portion comprises portion 503, the another first portion comprises portion 507, the additional first portion 511, the one second portion comprises portion 505, and the additional second portion comprises portion 509. Example D comprises three first neutral planes 1807a, 1807b, and 1807c and two second neutral planes 1809a and 1809b, where the one first portion 503 comprises a one first neutral plane 1807a, the another first portion 507 comprises the another first neutral plane 1807b, the additional first portion 511 comprises the additional first neutral plane 1807c, and the one second portion 505 comprises a one second neutral plane 1609a, and an additional second portion 509 comprises an additional second neutral plane 1609b. Example D was able to withstand bending to a parallel plate distance of 8 mm without any mechanical instability.

TABLE 3

Properties of Example C corresponding to FIG. 17

| Portion | Sub-Portion | Young’s Modulus (MPa) | Thickness (µm) | Poisson’s Ratio | Thickness Label |
|---|---|---|---|---|---|
| 503 | 513 | 7,500 | 100 | 0.30 | 504 (514, 516) |
| | 515 | 2,760 | 80 | 0.25 | |
| 505 | | 0.1 | 100 | 0.495 | 506 |
| 507 | 517 | 3,750 | 60 | 0.30 | 508 (518, 520) |
| | 519 | 5,400 | 100 | 0.38 | |
| 509 | | 0.1 | 50 | 0.495 | 510 |
| 511 | 521 | 100 | 75 | 0.35 | 512 (522, 524) |
| | 523 | 71,000 | 30 | 0.22 | |

TABLE 4

Properties of Example D corresponding to FIG. 18

| Portion | Sub-Portion | Type | Young’s Modulus (MPa) | Thickness (µm) | Poisson’s Ratio | Thickness Label |
|---|---|---|---|---|---|---|
| 503 | 513 | 1 | 7,500 | 100 | 0.30 | 504 (514, 516) |
| | 515 | | 2,760 | 80 | 0.25 | 406 |
| 505 | | 2 | 0.01 | 100 | 0.495 | 506 |
| 507 | 517 | 1 | 3,750 | 60 | 0.30 | 508 (518, 520) |
| | 519 | | 5,400 | 100 | 0.38 | 410 |
| 509 | | 2 | 0.01 | 50 | 0.495 | 510 |
| 511 | 521 | 1 | 100 | 75 | 0.35 | 512 (522, 524) |
| | 523 | | 71,000 | 30 | 0.22 | |

Example E resembles the foldable apparatus 601 shown in FIG. 6 with properties shown in Table 5. In Example E, portions 605, 609, and 613 comprise a Young’s modulus of 0.1 MPa. In Example E, the Young’s modulus of portion 605 (e.g., maximum Young’s modulus of portion 605) is more than 500 times, 750 times, 1,000 times, 1,500 times, and 5,000 times, 8,000 times, 10,000 times, 15,000 times (25,000 times) less than the Young’s modulus of portion 603 (e.g., minimum Young’s modulus of portion 603). The Young’s modulus of the other second portions 609 and 613 relative to the Young’s modulus of the corresponding adj acent pairs of first portions is less than the Young’s modulus by a greater multiple (28,000) than for portion 605 (25,000). Consequently, Example E comprises four first portions 603, 607, 611, and 615 and three second portions 605, 609, and 613. Example E comprises four first neutral planes 1907a, 1907b, 1907c, and 1907d and three second neutral planes 1909a, 1909b, and 1909c, where the one first portion 603 comprises a one first neutral plane 1907a, an another first portion 607 comprises an another first neutral plane 1907b, the additional first portion 611 comprises the additional first neutral plane 1907c, the further first portion 615 comprises the further first neutral plane 1907d, the one second portion 605 comprises a one second neutral plane 1909a, the another second portion 609 comprises an another neutral plane 1909b, and the additional second portion 613 comprises an additional neutral plane 1909c. Example E was able to withstand bending to a parallel plate distance of 8 mm without any mechanical instability.

TABLE 5

Properties of Example E corresponding to FIG. 19

| Portion | Type | Young’s Modulus (MPa) | Thickness (µm) | Poisson’s Ratio | Thickness Label |
|---|---|---|---|---|---|
| 603 | 1 | 2,500 | 95 | 0.34 | 604 |
| 605 | 2 | 0.1 | 36 | 0.495 | 606 |
| 607 | 1 | 2,800 | 60 | 0.37 | 608 |
| 609 | 2 | 0.1 | 36 | 0.495 | 610 |
| 611 | 1 | 2,800 | 170 | 0.37 | 612 |
| 613 | 2 | 0.1 | 36 | 0.495 | 614 |
| 615 | 1 | 71,000 | 67 | 0.22 | 616 |

Example F resembles the foldable apparatus 701 shown in FIG. 7 with properties shown in Table 6. In Example E, second portions 705, 709, 713, and 717 comprise a Young’s modulus of 0.1 MPa. In Example F, the Young’s modulus of second portion 709 (e.g., maximum Young’s modulus of second portion 709) is more than 500 times, 750 times, 1,000 times, 1,500 times, 5,000 times, 8,000 times, 10,000 times, and 15,000 times (25,000 times) less than the Young’s modulus of first portion 707 (e.g., minimum Young’s modulus of first portion 707). The Young’s modulus of the other second portions 705, 713, and 717 relative to the Young’s modulus of the corresponding adjacent pairs of first portions is less than the Young’s modulus by a greater multiple (27,600, 37,500, 72,000) than for second portion 709 (25,000). Consequently, Example F comprises five first portions 703, 707, 711, 715, and 719 and four second portions 705, 709, 713, and 717. Example F comprises five first neutral planes 2007a, 2007b, 2007c, 2007d, and 2007e and four second neutral planes 2009a, 2009b, 2009c, and 2009d, where the one first portion 703 comprises a one first neutral plane 2007a, an another first portion 707 comprises an another first neutral plane 2007b, the additional first portion 711 comprises the additional first neutral plane 2007c, the further first portion 715 comprises the further first neutral plane 2007d, a still another first portion 719 comprises a still another first neutral plane 2007e, the one second portion 705 comprises a one second neutral plane 2009a, the another second portion 709 comprises an another neutral plane 2009b, the additional second portion 713 comprises an additional neutral plane 2009c, and the further second portion 717 comprises a further second neutral plane 2009d. Example F was able to withstand bending to a parallel plate distance of 12 mm without any mechanical instability.

TABLE 6

Properties of Example F corresponding to FIG. 20

| Portion | Type | Young’s Modulus (MPa) | Thickness (µm) | Poisson’s Ratio | Thickness Label |
|---|---|---|---|---|---|
| 703 | 1 | 7,200 | 55 | 0.34 | 704 |
| 705 | 2 | 0.1 | 25 | 0.495 | 706 |
| 707 | 1 | 2,500 | 45 | 0.34 | 708 |
| 709 | 2 | 0.1 | 25 | 0.495 | 710 |
| 711 | 1 | 2,760 | 40 | 0.25 | 712 |
| 713 | 2 | 0.1 | 25 | 0.495 | 714 |
| 715 | 1 | 3,750 | 40 | 0.30 | 716 |
| 717 | 2 | 0.1 | 25 | 0.495 | 718 |
| 719 | 1 | 71,000 | 75 | 0.22 | 720 |

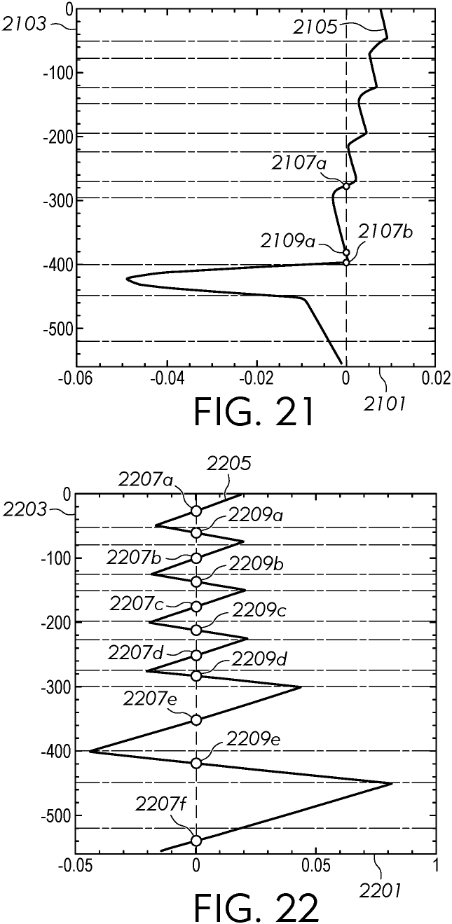

Examples G-H resemble foldable apparatus 801 shown in FIG. 8 with properties shown in Tables 7-8, respectively. In Example G, portions 805, 809, 813, 817, and 821 comprises a Young’s modulus of 0.2 MPa. As shown in FIG. 21, the foldable apparatus comprises two first neutral axes 2107a and 2107b and a single second neutral axis 2109a. In Example G, the Young’s modulus of portion 821 (e.g., maximum Young’s modulus of portion 821) is 500 times less than the Young’s modulus of sub-portions 831 and 833 (e.g., minimum Young’s modulus of first portion 823). Consequently, portions 821 and 823 are the same portion type (e.g., first, second). This means that in Example G either (i) the number of first portions is four since portions 821 and 823 comprise a first portion but that there is only two second portion - rather than one less than the number of first portions, namely three - or (ii) the number of first portions is equal to the number of second portions and a second portion comprising portions 821 and 823 comprises the second major surface 203 - rather than at least one first portion being positioned between the second portion and the first major surface 201 and second major surface 201. Example G exhibited wrinkling (see FIG. 11) at a parallel plate distance of 32.5 mm.

In contrast to Example G, second portions 805, 809, 813, 817, and 821 of Example H comprises a Young’s modulus of 0.01 MPa instead of 0.2 MPa. In Example H, the Young’s modulus of second portion 821 (e.g., maximum Young’s modulus of second portion 821) is more than 500 times, 750 times, 1,000 times, 1,500 times, and 5,000 times (10,000 times) less than the Young’s modulus of sub-portions 831 and 833 (e.g., minimum Young’s modulus of first portion 823). The Young’s modulus of the other second portions 805, 809, and 817 relative to the Young’s modulus of the corresponding adjacent pairs of first portions is less than the Young’s modulus by a greater multiple (330,000) than for second portion 821 (10,000). Consequently, Example H comprises six first portions 803, 807, 811, 815, 819, and 823 and five second portions 805, 809, 813, 817, and 821.

Example H comprises six first neutral planes 2207a, 2207b, 2207c, 2207d, 2207e, and 2207f and five second neutral planes 2209a, 2209b, 2209c, 2209d, and 2209e, where the one first portion 803 comprises a one first neutral plane 2207a, an another first portion 807 comprises an another first neutral plane 2207b, the additional first portion 811 comprises the additional first neutral plane 2207c, the further first portion 815 comprises the further first neutral plane 2207d, a still another first portion 819 comprises a still another first neutral plane 2207e, a yet another first portion 823 comprises a yet another first neutral plane 2209f, the one second portion 805 comprises a one second neutral plane 2209a, the another second portion 809 comprises an another second neutral plane 2209b, the additional second portion 813 comprises an additional second neutral plane 2209c, the further second portion 817 comprises a further second neutral plane 2209d, and a still another second portion 821 comprises a still another second neutral plane 2209e. Example H was able to withstand bending to a parallel plate distance of 3 mm without any mechanical instability.

TABLE 7

Properties of Example G corresponding to FIG. 21

| Portion | Sub-Portion | Young’s Modulus (MPa) | Thickness (µm) | Poisson’s Ratio | Thickness Label |
|---|---|---|---|---|---|
| 803 | | 3,300 | 50 | 0.35 | 804 |
| 805 | | 0.2 | 25 | 0.499 | 806 |
| 807 | | 3,300 | 50 | 0.35 | 808 |
| 809 | | 0.2 | 25 | 0.499 | 810 |
| 811 | | 3,300 | 50 | 0.35 | 812 |
| 813 | | 0.2 | 25 | 0.499 | 814 |
| 815 | | 3,300 | 50 | 0.35 | 816 |
| 817 | | 0.2 | 25 | 0.499 | 818 |
| 819 | | 3,300 | 100 | 0.35 | 820 |
| 821 | | 0.2 | 50 | 0.499 | 822 |
| 823 | 831 | 100 | 75 | 0.40 | 824 (832, 834) |
| | 833 | 71,000 | 30 | 0.22 | |

TABLE 8

Properties of Example H corresponding to FIG. 22

| Portion | Sub-Portion | Typ e | Young’s Modulus (MPa) | Thickness (µm) | Poisson’s Ratio | Thickness Label |
|---|---|---|---|---|---|---|
| 803 | | 1 | 3,300 | 50 | 0.35 | 804 |
| 805 | | 2 | 0.01 | 25 | 0.49 | 806 |
| 807 | | 1 | 3,300 | 50 | 0.35 | 808 |
| 809 | | 2 | 0.01 | 25 | 0.49 | 810 |
| 811 | | 1 | 3,300 | 50 | 0.35 | 812 |
| 813 | | 2 | 0.01 | 25 | 0.49 | 814 |
| 815 | | 1 | 3,300 | 50 | 0.35 | 816 |
| 817 | | 2 | 0.01 | 25 | 0.49 | 818 |
| 819 | | 1 | 3,300 | 100 | 0.35 | 820 |
| 821 | | 2 | 0.01 | 50 | 0.49 | 822 |
| 823 | 831 | 1 | 100 | 75 | 0.40 | 824 (832, 834) |
| | 833 | | 71,000 | 30 | 0.22 | |

Overall, example embodiments comprising Examples B, D-F, and H were able to withstand bending to a parallel plate of about 12 mm or less (e.g., about 8 mm, about 6 mm, about 3 mm) without exhibiting mechanical instabilities (e.g., wrinkling, buckling) while comparative examples comprising Example C wrinkled at 100 mm parallel plate distance, Example A wrinkled at 34 mm parallel plate distance, and Example G wrinkled at 32 mm parallel plate distance. Examples B, D-F, and H all had a first portion comprising the first major surface 201 and another first portion comprising the second major surface 203. Also, Examples B, D-F, and H all had a number of second portions that was one less than the number of first portions of the plurality of first portions. Additionally, Examples B, D-F, and H also had a number of first neutral planes equal to the number of first portions and a number of second neutral planes equal to the number of second neutral planes. Moreover, the number of second neutral planes was one less than the number of first neutral planes.

A foldable apparatus according the embodiments of the disclosure can provide several technical benefits. For example, the foldable substrate can provide small effective minimum bend radii while simultaneously providing good impact and puncture resistance. The foldable apparatus can comprise glass-based and/or ceramic-based materials comprising one or more compressive stress regions, which can further provide increased impact resistance and/or puncture resistance while simultaneously facilitating good bending performance. Providing at least one second portion comprising a much lower (e.g., from about 500 times to about 500,000 times, from about 10,000 times to about 100,000 times) Young’s modulus than an adjacent pair of first portions can reduce bend-induced stresses on one or more of the first portions in the adjacent pair of first portions. Reducing bend-induced stresses can reduce (e.g., decreases, eliminate) bend-induced mechanical instabilities of the foldable apparatus. Also, reducing bend-induced stresses can reduce fatigue of the foldable apparatus while increasing the reliability and/or durability of the foldable apparatus. Likewise, providing a second portion comprising a flexural rigidity of second portion that is about 100 times or more greater than a flexural rigidity of an adjacent first portion can reduce bend-induced stresses on the first portion, bend-induced mechanical instabilities in the foldable apparatus, and/or fatigue of the foldable apparatus. Providing a foldable apparatus with an apparatus bend force near (e.g., within a factor of 2, from about 0.5 times to about 1 times) a total bend total bend force from bending each first portion individually can enable low user-applied forces to fold the foldable apparatus. Also, this can reflect a decreased coupling of bend-induced stresses between adjacent pairs of first portions. Providing a foldable apparatus where each first portion comprises a first neutral plane and each second portion comprises a second neutral plane can reduce bend-induced stresses within the first portions and at least one second portion. As discussed above, reduced bend-induced stresses can reduce bend-induced mechanical instabilities in the foldable apparatus and/or fatigue of the foldable apparatus.

Directional terms as used herein-for example, up, down, right, left, front, back, top, bottom—are made only with reference to the figures as drawn and are not intended to imply absolute orientation.

It will be appreciated that the various disclosed embodiments may involve features, elements, or steps that are described in connection with that embodiment. It will also be appreciated that a feature, element, or step, although described in relation to one embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises embodiments having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. Whether or not a numerical value or endpoint of a range in the specification recites “about,” the numerical value or endpoint of a range is intended to include two embodiments: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C. As used herein, the terms “comprising” and “including”, and variations thereof shall be construed as synonymous and openended unless otherwise indicated.

The above embodiments, and the features of those embodiments, are exemplary and can be provided alone or in any combination with any one or more features of other embodiments provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the embodiments herein provided they come within the scope of the appended claims and their equivalents.

What is claimed is:

1-27. (canceled)

28. The foldable apparatus of claim 31, wherein:
the at least one second portion comprising at least five second portions.

29. The foldable apparatus of claim 31, wherein each second portion of the at least five second portions comprises a thickness in a range from about 10 micrometers to about 250 micrometers.

30. The foldable apparatus of claim 28, wherein each first portion of the corresponding adjacent pair of first portions comprises a first neutral plane, and each second portion of the at least one second portion comprises a second neutral plane.

31. A foldable apparatus comprising:
a plurality of first portions, each first portion of the plurality of first portions comprises a first neutral plane; and
at least one second portion positioned between a corresponding adjacent pair of first portions of the plurality of first portions, each second portion of the at least one second portion comprising a second neutral plane,
wherein each second portion of the at least one second portion comprises a maximum Young’s modulus that is in a range from about 500 times to about 500,000 times less than a minimum Young’s modulus of the corresponding adjacent pair of first portions.

32. The foldable apparatus of claim 31, wherein an apparatus bend force is in a range from about 0.5 times to about 1 times a total bend force comprising a force to bend each first portion of the plurality of first portions individually and the at least one second portion individually.

33. The foldable apparatus of claim 31, wherein each second portion of the at least one second portion comprises a maximum Young’s modulus of about 0.5 MegaPascals or less.

34. The foldable apparatus of claim 31, wherein each second portion of the at least one second portion comprises a Poisson’s ratio of about 0.49 or more.

35. The foldable apparatus of claim 31, wherein a flexural rigidity of each second portion of the at least one second portion is less than a flexural rigidity of a first portion of the corresponding adjacent pair of first portions by about 1,000 times or more.

36. The foldable apparatus of claim 35, wherein the flexural rigidity of each second portion of the at least one second portion is less than the flexural rigidity of the first portion of the corresponding adjacent pair of first portions by about 4,000 times to about 40,000 times.

37. The foldable apparatus of claim 31, wherein a number of second portions of the at least one second portion is one less than a number of first portions of the plurality of first portions.

38. The foldable apparatus of claim 31, wherein at least one first portion of the plurality of first portions comprises two or more first sub-portions, one first sub-portion of the two or more first sub-portions comprises a different composition than a composition of another first sub-portion of the two or more first sub-portions.

39. The foldable apparatus of claim 38, wherein the two or more first sub-portions comprises three or more first sub-portions further comprising an additional sub-portion, the one first sub-portion is positioned between the another first sub-portion and the additional first sub-portion.

40. The foldable apparatus of claim 39, wherein a second portion of the at least one second portion adjacent to the at least one first portion contacts the one first sub-portion but not the another first sub-portion.

41. The foldable apparatus of claim 31, wherein a magnitude of a difference between an index of refraction of the at least one second portion and the index of refraction of an adjacent first portion of the corresponding adjacent pair of first portions is about 0.1 or less.

42. The foldable apparatus of claim 31, wherein the at least one second portion comprises an optically clear adhesive and/or a pressure sensitive adhesive.

43. The foldable apparatus of claim 31, wherein the at least one second portion comprises one or more of a silicone-based polymer, an acrylate-based polymer, an epoxy-based polymer, a thiol-containing polymer, a polyimide-based material, or a polyurethane.

44. The foldable apparatus of claim 31, wherein at least one first portion of the plurality of first portions comprises a glass-based substrate.

45. The foldable apparatus of claim 31, wherein at least one first portion of the plurality of first portions comprises a ceramic-based substrate.

46. A consumer electronic product, comprising:
a housing comprising a front surface, a back surface, and side surfaces;
electrical components at least partially within the housing, the electrical components comprising a controller, a memory, and a display, the display at or adjacent the front surface of the housing; and
a cover substrate disposed over the display,
wherein at least one of a portion of the housing or the cover substrate comprises a portion of the foldable apparatus of claim 31.
